(19) United States
(12) Patent Application Publication
(10) Pub. No.: US 2026/0066847 A1
(43) Pub. Date: Mar. 5, 2026

(54) DETERMINING SOILING MAPS BASED ON SOILING LOSS OF PHOTOVOLTAIC PANELS

(71) Applicants: ACWA POWER Company, Riyadh (SA); King Abdullah University of Science and Technology, Thuwal (SA)

(72) Inventors: Georgiy STENCHIKOV, New York, NY (US); Suleiman MOSTAMANDI, Thuwal (SA); Ilia SHEVCHENKO, Thuwal (SA); Ahmed Hesham BALAWI, Riyadh (SA); Dania KABAKEBJI, Erfurt (DE)

(73) Assignees: ACWA POWER Company, Riyadh (SA); King Abdullah University of Science and Technology, Thuwal (SA)

(21) Appl. No.: 19/318,275

(22) Filed: Sep. 3, 2025

Related U.S. Application Data
(60) Provisional application No. 63/691,237, filed on Sep. 5, 2024.

(51) Int. Cl. H02S 50/00; H02S 20/30; H02S 40/10

(52) U.S. Cl. CPC H02S 50/00; H02S 20/30; H02S 40/10

(57) ABSTRACT

Present disclosure discloses determining soiling maps based on soiling loss of photovoltaic panels (PV). Receive sensor data associated with accumulation of plurality of particles on PV panels and environmental data. Sensor data is received for each time interval of a plurality of predefined time intervals. Sensor data includes particle data associated with plurality of particles, tilt angle data, and orientation data. Determine deposition rate data associated with the accumulation of plurality of particles on PV panel based on sensor data and the environmental data. Determine soiling loss data associated with PV panel based on deposition rate data. Determine correlation coefficient data based on deposition rate data and soiling loss data. Correlation coefficient data indicates one or more correlation coefficients between corresponding soiling loss and observational data. Generate one or more soiling maps associated with PV panel based on correlation coefficient data. Output one or more soiling maps for PV panels.

### CROSS-REFERENCE TO RELATED APPLICATION

This application claims priority to U.S. Provisional Patent Application Ser. No. 63/691,237, filed Sep. 5, 2024 and entitled SYSTEM AND METHOD FOR ESTIMATING AND PREDICTING SOILING LOSS DUE TO DUST ACCUMULATED ON PHOTOVOLTAIC (PV) PLANTS, the disclosure which is incorporated herein by reference.

### TECHNOLOGICAL FIELD

The present invention generally relates to solar power plants, more particularly, determining soiling maps based on soiling loss of photovoltaic panels.

### BACKGROUND

The photovoltaic (PV) industry has rapidly expanded due to advancements in electrical engineering, as solar energy has become an increasingly favourable renewable energy source. PV power plants serve as facilities that convert solar energy into electricity, utilizing clean and renewable resources to harness solar radiation for power generation. However, the accumulation of dust and dirt on solar panel surfaces, known as soiling, poses a significant challenge, which can greatly reduce the ability of the solar panel surfaces to capture sunlight, leading to decreased efficiency in electricity generation.

Existing systems disclose soil detection mechanisms, which use reference panels and periodic manual inspections to estimate dust accumulation. Further, the existing systems lack advanced analytics to correlate soiling loss with environmental factors for estimating dust accumulation. Furthermore, the existing systems merely rely on the integration of limited sensor data, which often leads to the estimation of dust accumulation in fixed areas of the PV power plants.

Currently, there is no reliable tool for estimating soiling loss that can accurately forecast soiling for solar power plants across an entire region. To validate the estimation collected regarding the soiling loss, it is essential to benchmark a measurement obtained from the estimation against a standard reference. To address challenges faced by the existing systems, various techniques have been developed to measure and quantify soiling rates. However, the existing systems are primarily focused on retrieving isolated measurements at specific locations of the solar panels. Thus, the existing systems lack a comprehensive and spatially resolved approach. Further, the existing systems fail to capture an accurate estimation, determine soiling rates over wider areas, accurately assess soiling loss assessment and the like. Thus, the existing systems significantly impact the efficiency and lifespan of the solar panels. Therefore, there is a requirement to develop a reliable system for accurately predicting the soiling loss in solar power plants across one or more regions.

### BRIEF SUMMARY

The present invention generally relates to solar power plants, more particularly, determining soiling maps based on soiling loss of photovoltaic panels.

In one aspect, a system for determining soiling loss is provided. The system may include one or more processors, and a memory coupled to the one or more processors. The memory may store instructions, which when executed by the one or more processors, may be configured to receive sensor data associated with an accumulation of particles on a photovoltaic (PV) panel and environmental data associated with the PV panel. The sensor data may be received for each time interval of a plurality of predefined time intervals. The sensor data may include particle data associated with a plurality of particles, tilt angle data, and orientation data. Based on the sensor data and the environmental data, the system may be configured to determine deposition rate data associated with the accumulation of the plurality of particles on the PV panel. The deposition rate data may indicate a particle deposition rate for each tilt angle of one or more predefined tilt angles of the PV panel at each time interval of the plurality of predefined time intervals. The system may be configured to determine soiling loss data associated with the PV panel based on the deposition rate data. The soiling loss data may indicate a soiling loss for each tilt angle of the one or more predefined tilt angles of the PV panel at each time interval of the plurality of predefined time intervals. The system may be configured to determine correlation coefficient data for the PV panel based on the deposition rate data and the soiling loss data. The correlation coefficient data may indicate one or more correlation coefficients between the soiling loss and observational data. The observational data may be based on the deposition rate data and the sensor data at a corresponding time interval of the plurality of predefined time intervals. The system may be configured to generate one or more soiling maps associated with the PV panel based on the correlation coefficient data. The system may be configured to output the one or more soiling maps for the PV panel.

In an embodiment, the one or more processors may be further configured to receive time interval data associated with a particular prediction time interval. The particular prediction time interval may be associated with at least one time interval of the plurality of predefined time intervals. Further, one or more processors may be configured to determine soiling loss prediction data for the particular prediction time interval based on the time interval data and the correlation coefficient data.

In an embodiment, the one or more processors may be further configured to retrieve energy parameter data associated with the PV panel. Further, one or more processors may be configured to generate predicted energy output data associated with the particular prediction time interval based on the energy parameter data and the soiling loss prediction data.

In an embodiment, the one or more processors may be further configured to determine average correlation coefficient data for each tilt angle of the one or more predefined tilt angles of the PV panel, based on the correlation coefficient data. Further, one or more processors may be configured to determine regional soiling loss data for a geographical region associated with the PV panel based on the average correlation coefficient data. Furthermore, one or more processors may be configured to determine the soiling loss prediction data for the particular prediction time interval for the geographical region based on the regional soiling loss data.

In an embodiment, the PV panel may be associated with a plurality of PV panels of a solar power plant. The one or more processors may be further configured to determine correlation coefficient data for each PV panel of the plurality of PV panels based on the deposition rate data for each PV panel of the plurality of PV panels. The one or more processors may be further configured to determine average deposition rate data for each tilt angle of the one or more predefined tilt angles of each PV panel of the plurality of PV panels, based on the corresponding determined deposition rate data. Furthermore, the one or more processors may be further configured to determine the regional soiling loss data for the geographical region based on the average deposition rate data of each of the plurality of PV panels.

In an embodiment, the one or more processors may be configured to generate visual indication data associated with the geographical region based on the soiling loss prediction data for the particular prediction time interval for the geographical region. The visual indication data may be associated with the one or more soiling maps. The one or more processors may be further configured to display the one or more soiling maps based on the visual indication data.

In an embodiment, the environmental data may include at least one of wind data, humidity data, atmospheric pressure data, or temperature data.

In an embodiment, the one or more processors may be further configured to receive the sensor data associated with one or more sensors associated with the PV panel. The sensor data may be associated with the accumulation of the plurality of particles. Each of the one or more sensors may be arranged at a corresponding angle with respect to the PV panels.

In an embodiment, a first set of sensors of the one or more sensors may be arranged in a first predefined orientation associated with the PV panel, and a second set of sensors may be arranged in a second predefined orientation associated with the PV panel.

In an embodiment, the PV panel may be movable to adjust a tilt angle thereof, and the tilt angle of the PV panel may be adjusted based on the one or more predefined tilt angles.

In an embodiment, the correlation coefficient associated with a specific time interval of the plurality of predefined time intervals corresponds to a ratio of the soiling loss at the specific time interval and the particle deposition rate at the specific time interval.

In an embodiment, each of the plurality of particles has a diameter lesser than or equal to 10 micrometres.

In an embodiment, the sensor data may include solar irradiance data of the PV panel, energy production metric data of the PV panel, module temperature data of the PV panel, or light transmittance data of the PV panel.

In another aspect, a method for determining soiling loss is provided. The method may include receiving, by a system, sensor data associated with an accumulation of a plurality of particles on a PV panel and environmental data associated with the PV panel. The sensor data may be received for each time interval of a plurality of predefined time intervals. The sensor data may include particle data associated with the plurality of particles, the tilt angle data, and the orientation data. The method may include determining, by the system, deposition rate data associated with the accumulation of the plurality of particles on the PV panel based on the sensor data and the environmental data. The deposition rate data may indicate a particle deposition rate for each tilt angle of the one or more predefined tilt angles of the PV panel at each time interval of the plurality of predefined time intervals. The method may include determining, by the system, soiling loss data associated with the PV panel based on the deposition rate data. The soiling loss data may indicate a soiling loss for each tilt angle of the one or more predefined tilt angles of the PV panel at each time interval of the plurality of predefined time intervals. The method may include determining, by the system, correlation coefficient data for the PV panel based on the deposition rate data and the soiling loss data. The correlation coefficient data may indicate one or more correlation coefficients between the corresponding soiling loss and observational data. The observational data may be based on the deposition rate data and the sensor data at corresponding time interval of the plurality of predefined time intervals. The method may include generating, by the system, one or more soiling maps associated with the PV panel based on the correlation coefficient data. The method may include outputting, by the system, the one or more soiling maps for the PV panel.

In an embodiment, the method may include receiving, by the system, time interval data associated with a particular prediction time interval. The particular prediction time interval may be associated with at least one time interval of the plurality of predefined time intervals. The method may include determining, by the system, soiling loss prediction data for the particular prediction time interval based on the time interval data and the correlation coefficient data.

In an embodiment, the method may include retrieving, by the system, energy parameter data associated with the PV panel. The method may include generating, by the system, predicted energy output data associated with the particular prediction time interval based on the energy parameter data and the soiling loss prediction data.

In an embodiment, the method may include receiving, by the system, the sensor data associated with the accumulation of the plurality of particles from one or more sensors associated with the PV panel. Each of the one or more sensors may be arranged at a corresponding angle from the PV panel.

In another aspect, a computer program product, which may include a non-transitory computer readable medium having stored thereon computer executable instructions. Further, the computer executable instructions, when executed by one or more processors, cause the one or more processors to carry out operations, which may include receiving sensor data associated with an accumulation of a plurality of particles on a photovoltaic (PV) panel. The sensor data may be received for each time interval of a plurality of predefined time intervals, and the sensor data may include particle data associated with the plurality of particles, tilt angle data, and orientation data. Further, the operations may include determining deposition rate data associated with the accumulation of the plurality of particles on the PV panel based on the sensor data. The deposition rate data may indicate a particle deposition rate for each tilt angle of one or more predefined tilt angles of the PV panel at each time interval of the plurality of predefined time intervals. Furthermore, the operations may include determining soiling loss data associated with the PV panel based on the deposition rate data. The soiling loss data may indicate the soiling loss for each tilt angle of the one or more predefined tilt angles of the PV panel at each time interval of the plurality of predefined time intervals. The operations may include determining correlation coefficient data for the PV panel based on the deposition rate data and the soiling loss data. The correlation coefficient data may indicate one or more correlation coefficients between the soiling loss and the observational data. The observational data may be based on the deposition rate data and the sensor data at corresponding time interval of the plurality of predefined time intervals. The operations may include generating one or more soiling maps associated with the PV panel based on the correlation coefficient data. The operations may include outputting the one or more soiling maps for the PV panel.

Further features and advantages will become apparent from the following detailed description when taken in conjunction with the accompanying drawings.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a diagram that illustrates a network environment of a system for determining soiling maps based on soiling loss of photovoltaic (PV) panels, in accordance with an embodiment of the present disclosure;

FIG. 2 illustrates a block diagram of the system of FIG. 1, in accordance with an embodiment of the present disclosure;

FIG. 3 is a diagram that illustrates exemplary operations for the calculation of correlation coefficients, in accordance with an embodiment of the disclosure;

FIG. 4 is a diagram that illustrates an arrangement of each sensor of the one or more sensors associated with each PV panel of the plurality of PV panels, in accordance with an embodiment of the disclosure;

FIG. 5A is a diagram that illustrates a schematic diagram of an arrangement of one or more sensors associated with the plurality of PV panels in an east-west orientation, in accordance with an embodiment of the disclosure;

FIG. 5B is a diagram that illustrates a schematic diagram of an arrangement of one or more sensors associated with the plurality of PV panels in a north-south orientation, in accordance with an embodiment of the disclosure;

FIG. 5C and FIG. 5D, in combination, illustrates a schematic diagram of an arrangement of one or more tilt angles of one or more sensors associated with the plurality of PV panels, in accordance with an embodiment of the disclosure;

FIG. 6 and FIG. 7 collectively illustrates a graphical representation of soiling maps associated with the deposition rate data in a pre-determined region, in accordance with an embodiment of the present disclosure;

FIG. 8 illustrates a graphical representation of soiling maps associated with a rate of soiling loss in the pre-determined region, in accordance with an embodiment of the present disclosure;

FIG. 9 illustrates a schematic diagram of a passive dust sampler, in accordance with an embodiment of the disclosure; and

FIG. 10 illustrates a flowchart of an exemplary method for determining solar photovoltaic soiling loss, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in the form of block diagrams to avoid obscuring the present disclosure.

Some embodiments of the present disclosure will now be described fully hereinafter with reference to accompanying drawings, in which some, but not all, embodiments of the disclosure are shown. Indeed, various embodiments of the disclosure may be embodied in different forms and should not be construed as limited to the embodiments set forth herein; rather, these embodiments are provided so that the present disclosure may satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all are referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described, which may be exhibited by some embodiments and not by others. Similarly, various requirements are described that may support requirements of some embodiments in the disclosure, but not for the rest of the embodiments.

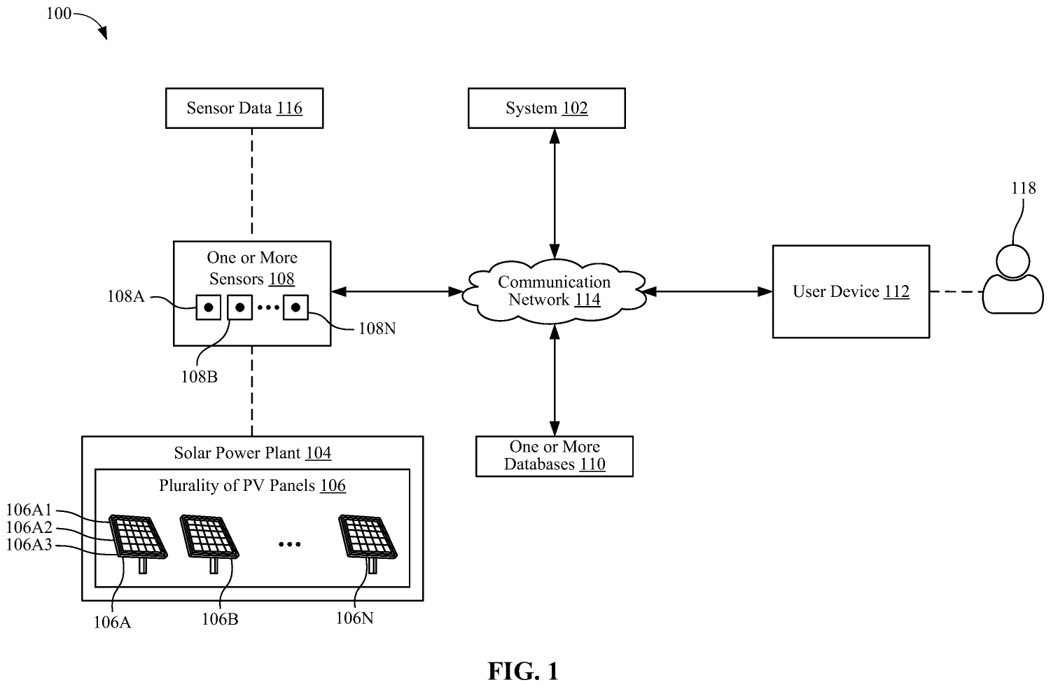

The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 10, a brief description concerning the various components of the present disclosure will now be briefly discussed. Reference will be made to the figures showing various embodiments of a system for calculating soiling loss due to dust accumulated on solar power plants.

Dust suspended in the atmosphere may reduce downward solar flux, thereby impeding energy generation, as the solar flux is a raw material for solar energy generation. Dust deposition on solar panel surfaces, known as soiling, further diminishes the efficiency of a photovoltaic (PV) panel associated with the solar power plant. Additionally, the dust deposition adversely affects the radiative cooling capability of the PV panel, exacerbating the reduction in solar energy production.

The present disclosure addresses a spatial variability and a temporal variability of the direct soiling effect on energy production, known as soiling losses. To support informed decision-making, the disclosure also details energy production losses that are attributable to dust suspended in the atmosphere (attenuation losses). Soiling presents a complex challenge that can significantly impact the energy yield and profitability of the PV panels, if not mitigated with cost-effective solutions. Therefore, understanding and predicting the rate of soiling losses and the dust-dimming effect is crucial for evaluating the energy yield of future PV projects.

The present disclosure includes both experimental and theoretical components. Experimentally, high-frequency observation was made to measure aerosol concentration in the near-surface layer of the PV panel, monthly dust deposition rates on the PV panel, local meteorological parameters, Aerosol Optical Depth (AOD), downward solar radiation, and the PV panel energy losses associated with dust deposition. Theoretically, the present disclosure describes ways to simulate dust deposition and soiling loss for a pre-determined region, and compares the simulations against observational data. Multi-year simulations of dust transport and deposition can be performed to develop a climatology of soiling and attenuation losses for the pre-determined region every month.

Existing solutions, such as soiling maps for dust deposition or dust concentration within the pre-determined region, provide insights into general environmental conditions. However, the soiling maps do not specifically address PV applications or directly focus on the soiling rates of the PV panels. The existing solutions lack focus on the impact of the environmental factors on the PV panels, thereby limiting the effectiveness of the PV panels in accurately predicting or estimating soiling rates.

The lack of reliable soiling loss prediction tools poses a significant challenge for the solar energy industry. Developing such a tool requires gathering soiling data from multiple locations to achieve high spatial resolution, which in turn necessitates deploying numerous sensors capable of accurately measuring PV soiling rates.

Limited availability of a PV panel measurement device, coupled with an emerging stage of PV panel analysis, impedes the establishment of a comprehensive soiling map. Consequently, the high spatial resolution can be achieved using the PV panel measurement device. Even though the PV panel measurement device is available, generating the soiling map remains a time-consuming process. Moreover, the advanced PV panel analysis lacks incorporation of the impact of meteorological conditions on soiling rates, as the PV panel analysis relies solely on historical soiling data. Thus, determining soiling measurements accurately, especially with the changing weather conditions, in the absence of the meteorological factors, is challenging.

To provide a reliable solution for predicting and mitigating soiling loss in the PV panels, there is a need for a comprehensive and innovative approach that combines spatial analysis and meteorological data integration. The present invention aims to offer a reliable system and method for determining soiling maps based on the soiling loss of the PV panels.

The proposed system may precisely quantify and predict the soiling losses based on one or more specific factors associated with the pre-determined region, which includes dust characteristics, energy yield forecasts, and the like. The proposed system includes granular dust data (including particle size) correlated with a physical orientation and a tilt angle of the PV panel, which provides a proactive approach to predict the soiling loss. The proposed system provides real-time data associated with the accumulation of dust particulates at a specific location in a particular time frame.

Therefore, the proposed system may provide a reliable and comprehensive tool to predict and mitigate the soiling losses in the PV panels. The proposed system may provide an accurate mechanism to determine soiling loss by enabling real-time monitoring and optimizing maintenance strategies. The proposed system may enhance the overall performance and cost-effectiveness of solar energy generation from the PV plants.

FIG. 1 is a diagram that illustrates a network environment 100 of a system 102 for determining soiling maps based on soiling loss of a photovoltaic (PV) panels, in accordance with an embodiment of the present disclosure. The network environment 100 includes a system 102, a solar power plant 104, a plurality of PV panels 106, one or more sensors 108, and one or more databases 110. The network environment 100 further includes a user device 112, a communication network 114, sensor data 116, and a user 118. The plurality of PV panels 106 may include a first PV panel 106A, a second PV panel 106B, up to an Nth PV panel 106N. The one or more sensors 108 may include a first sensor 108A, a second sensor 108B, up to an Ni sensor 108N.

In an embodiment, the solar power plant 104 may correspond to a large-scale grid-connected PV power system designed to supply power to the electrical grid. The solar power plant 104 may be configured to generate electricity from sunlight based on the photoelectric effect. In the photoelectric effect, specific materials, which include, but are not limited to Caesium, Zinc, and Gallium Arsenide, irradiate photons from sunlight to eject electrons and generate a direct current (DC). An inverter associated with the solar power plant 104 may then convert the DC into an alternating current (AC). The solar power plant 104 may be crucial for clean energy transition (refers to a process which may include, but not limited to, utilization of sunlight, wind power, hydropower, and the like, as a source to generate energy) thereby minimizing generation of polluting gases, and is a cost-effective option for electricity generation. Examples of the solar power plant 104 may include at least one of, but not limited to, a solar park, a solar farm, or a solar power field.

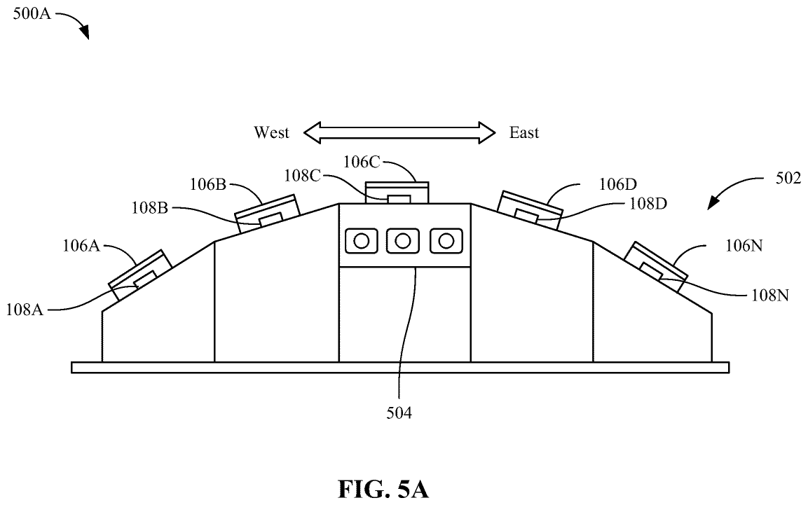

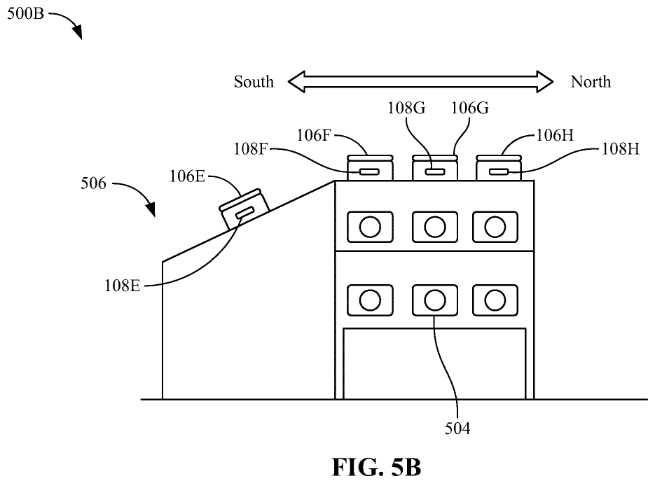

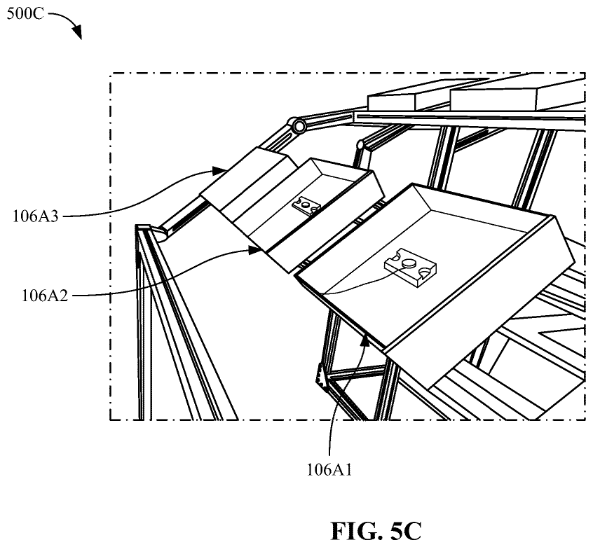

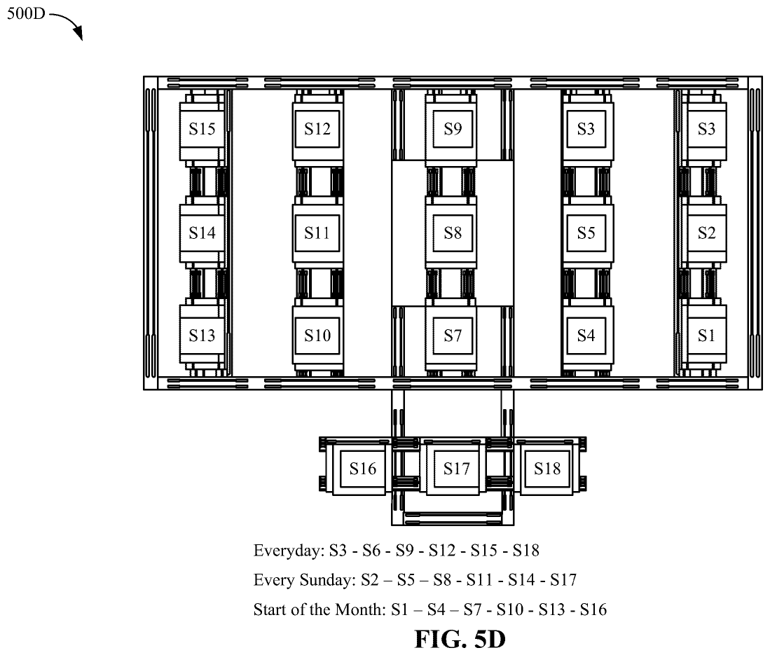

In an embodiment, the solar power plant 104 may include the plurality of PV panels 106. Each PV panel of the plurality of PV panels 106 may be composed of photovoltaic cells, which are capable of efficiently capturing sunlight and converting it into electricity. The plurality of PV panels 106 may be arranged in large arrays across vast areas. Further, the plurality of PV panels 106 may be directly connected to inverters that convert DC to AC, which is suitable for distribution through power lines. The AC may then be fed into a grid associated with the solar power plant 104. Examples of the plurality of PV panels 106 may include, but are not limited to, monocrystalline PV panels, polycrystalline PV panels, thin film PV panels, or Passivated Emitter and Rear Cell (PERC) PV panels. Further, the system 102 may include a set of three modules of the PV panels, including a first PV module 106A1, a second PV module 106A2, and a third PV module 106A3, where each one of the one or more sensors 108 is arranged at a predefined time interval. Details about the set of three modules of the PV panels are provided in FIG. 5C.

Each sensor of the one or more sensors 108 may include suitable logic, circuitry, interfaces, or software instructions that may be configured to detect and measure physical phenomena associated with the performance and the environmental conditions affecting the PV panel. Further, the system 102 is configured to convert the measured physical phenomena into digital or analog signals that can be processed by the system 102. The one or more sensors 108 may include the first sensor 108A, the second sensor 108B, up to the N^{th} sensor 108N. Each sensor of the one or more sensors 108 is arranged at a corresponding angle from the plurality of PV panels 106. Each sensor of the one or more sensors 108 may be configured to generate the sensor data 116 associated with the plurality of PV panels 106. The sensor data 116 may include, but not be limited to, particle data associated with a plurality of particles, tilt angle data, or orientation data. Examples of the one or more sensors 108 may include, but are not limited to, a temperature sensor, a soiling sensor, a humidity sensor, or an Infrared Sensor (IR).

In an embodiment, each database of the one or more databases 110 may include suitable logic, circuitry, interfaces, or software instructions that may be configured to organize the collection of data (for example, the sensor data 116) stored in a computer (say the system 102), as matrices. The one or more databases 110 may include, but are not limited to, a first database or a second database. The one or more databases 110 may be managed by a database management system (DBMS) that may facilitate data entry, storage, retrieval, and organization. The one or more databases 110 may allow easy access, management, modification, and organization of data. In an embodiment, each database of the one or more databases 110 may correspond to one of a relational database, such as a Structured Query Language (SQL) database, or a non-relational database, such as NoSQL. Further, the one or more databases 110 may support different query languages and data organization methods. The one or more databases 110 may support transactional and analytical data processing, enabling real-time recording of activities and informed decision-making through data analysis.

In an embodiment, the one or more databases 110 may be connected to the system 102 and the solar power plant 104 via the communication network 114. The one or more databases 110 may be configured to store data and information generated by the system 102 or the one or more sensors 108. In an embodiment, the one or more databases 110 may store the sensor data 116 generated by the one or more sensors 108. In yet another embodiment, the system 102 may be configured to retrieve the sensor data 116 associated with the plurality of PV panels 106 from the one or more databases 110.

In an embodiment, the user device 112 may include suitable logic, circuitry, interfaces, or software instructions that may be configured to render the alert associated with the soiling maps for the plurality of PV panels 106. In an exemplary embodiment, the user device 112 may be configured to output a visual indication of a soiling rate in a geographical region associated with the PV panel 106. Examples of the user device 112 may include, but are not limited to, a computing device, a smartphone, a cellular phone, a mobile phone, a mainframe machine, a server, a computer workstation, or a consumer electronic (CE) device.

In an embodiment, the communication network 114 may be wired, wireless, or a combination of wired and wireless communication networks, such as cellular, Wi-Fi, Internet, or local area networks. In some embodiments, the communication network 114 may include one or more networks such as a data network, a wireless network, a telephony network, or a combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, for example a proprietary cable or fiber-optic network, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IPMS), universal mobile telecommunications system (UMTS), as well as any other suitable wireless medium, for example worldwide interoperability for microwave access (WiMAX), Long Term Evolution (LTE) networks (for example LTE-Advanced Pro), 5G New Radio networks, International Telecommunication Union—International Mobile Telecommunications (ITU-IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), or any combination thereof.

In operation, the system 102 may be configured to receive sensor data 116 associated with an accumulation of the plurality of particles on the plurality of PV panels 106. Further, the system 102 may be configured to receive environmental data (e.g., wind, temperature, humidity, and atmospheric pressure). Further, the one or more sensors 108 coupled with the plurality of PV panels 106 may be configured to collect sensor data 116, which may include the accumulation of the plurality of particles on the plurality of PV panels 106. The plurality of particles on the plurality of PV panels 106 may refer to solid or liquid micro-sized substances (e.g., a particulate matter (PM10) concentration) that settle on the surfaces of the plurality of PV panels 106. The plurality of particles accumulated on the plurality of PV panels 106 may include, but are not limited to, dust particles, sand particles, chemical residues, or moisture. The system 102 may be configured to receive the sensor data 116 for each time interval of a plurality of predefined time intervals.

In an embodiment, the sensor data 116 may include, but not be limited to, particle data associated with the plurality of particles, tilt angle data, or orientation data. Further, the sensor data 116 may include, but not be limited to, the PM10 concentration data associated with the plurality of particles, refractive index data associated with the plurality of particles, or density data associated with the plurality of particles. Furthermore, the sensor data 116 may include, but not be limited to solar irradiance data of the plurality of PV panels 106, energy production metric data of the plurality of PV panels 106, module temperature data of the plurality of PV panels 106, or light transmittance data of the plurality of PV panels 106. The refractive index data may define the impact on at least one of light refraction or light absorption due to the accumulation of the plurality of particles. The density data may represent mass per unit of the dust particles accumulated on the plurality of PV panels 106. The tilt angle data may refer to an inclination of the plurality of PV panels 106 relative to a horizontal plane. The orientation data may refer to the direction of the plurality of PV panels 106.

In an embodiment, the PM10 concentration data may be associated with the plurality of particles having a diameter lesser than or equal to 10 micrometres. The PM10 concentration data may include, but not be limited to size of each particle of the plurality of particles, the shape of each particle of the plurality of particles, composition of each particle of the plurality of particles accumulated on the plurality of PV panels 106, which may affect light transmission. Further, the PM10 concentration data may indicate the concentration of the plurality of particles that may influence the soiling rate on the plurality of PV panels 106.

In an embodiment, the system 102 may be configured to determine the deposition rate data associated with the accumulation of the plurality of particles on the plurality of PV panels 106. Further, the deposition rate data can be obtained based on the sensor data 116 and the environmental data. The deposition rate data may indicate a rate of deposition for the plurality of particles for each tilt angle of one or more predefined tilt angles of the plurality of PV panels 106 at each time interval of the plurality of predefined time intervals. The system 102 is configured for measuring the deposition rate data using at least one of tilt angle data or orientation data associated with the plurality of PV panels 106, for each of the plurality of predefined time intervals.

In another embodiment, the system 102 may be configured to determine soiling loss data associated with the plurality of PV panels 106 based on the deposition rate data. The soiling loss data may indicate soiling loss for each tilt angle of the one or more predefined tilt angles of the plurality of PV panels 106 at each time interval of the plurality of predefined time intervals.

In another embodiment, the system 102 may be configured to determine correlation coefficient data for the plurality of PV panels 106 based on the deposition rate data and the soiling loss data. The correlation coefficient data may indicate one or more correlation coefficients between the corresponding soiling loss and the observational data. The observational data may be based on the deposition rate data and the sensor data 116 at the corresponding time interval of the plurality of predefined time intervals. The observational data includes information about the plurality of particles deposited on the plurality of PV panels 106, the tilt angle of the PV panel 106, and the PM10 concentration data. The soiling loss may refer to a reduction in the solar energy production by the plurality of PV panels 106, as a result of the dust deposition. The system 102 may be configured to perform analysis of a relationship between the accumulation of the plurality of particles and the reduction in the solar energy production by using the correlation coefficient data.

In another embodiment, the system 102 may be configured to generate one or more soiling maps associated with the plurality of PV panels 106 based on the correlation coefficient data. Further, the system 102 may be configured to output the one or more soiling maps for the plurality of PV panels 106. The one or more soiling maps may visually indicate a geographic region where one or more gradients depict the dust deposition on the plurality of PV panels 106.

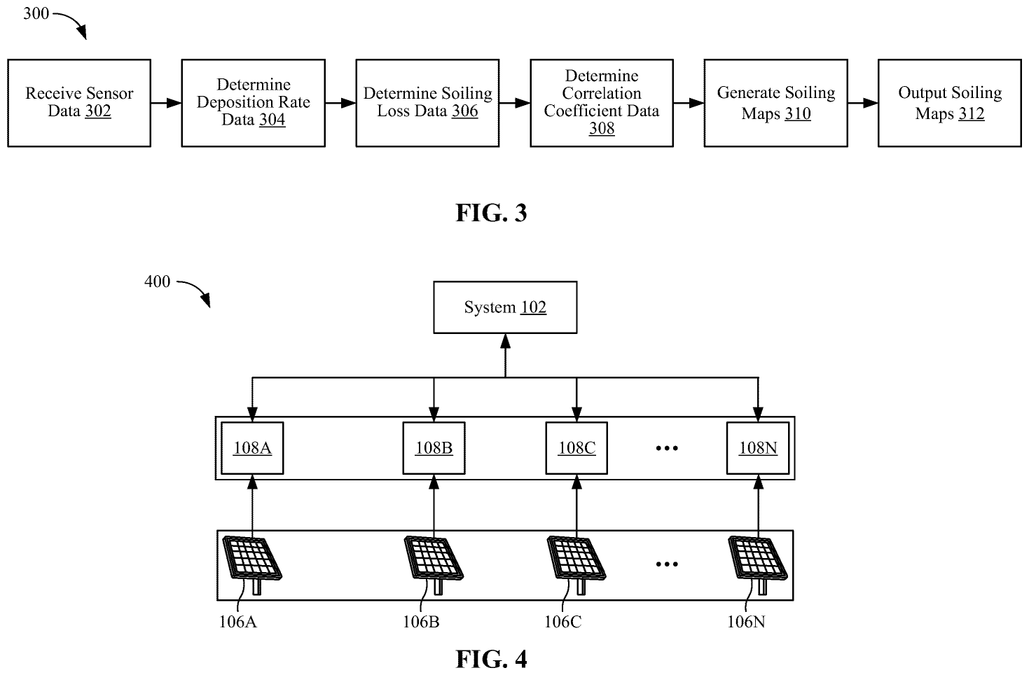

In another embodiment, the system 102 may include suitable logic, circuitry, interfaces, or software instructions that may be configured to determine soiling loss associated with the plurality of PV panels 106 of the solar power plant 104. The system 102 may be configured to perform a detailed analysis of the plurality of particles and the particulate matter (PM10 and above) deposition on the plurality of PV panels 106 through a series of integrated operations (refer FIG. 3). The system 102 may be configured to retrieve the sensor data 116 at one or more time intervals, such as, but not limited to, hourly, daily, weekly, or monthly. The system 102 may retrieve the sensor data 116 across different tilt angles of each PV panel of the plurality of PV panels 106. The system 102 further determines a deposition rate of the plurality of particles for each tilt angle and time interval. Further, the system 102 may be configured to determine the soiling loss based on the accumulation of the plurality of particles. Furthermore, the accumulation of the plurality of particles leads to a reduction in the solar energy production due to particle deposition.

Further, to address environmental factors such as wind effects, the system 102 may be configured to determine the correlation coefficient data, which is indicative of a ratio of soiling loss to the dust deposition rate every week. A dust coefficient may correspond to the ratio of the remaining plurality of particles on the plurality of PV panels 106 to the plurality of particles that may be displaced by the wind. The system 102 may be further configured to calculate an average dust coefficient for each week. Further, the system 102 is configured to calculate the average dust coefficient based on an individual dust coefficient for each particle of the plurality of particles at each tilt angle to derive regional soiling loss data specific to the pre-determined region.

Additionally, the system 102 provides a comprehensive assessment of the impact of the plurality of particles on the solar energy production, facilitating more informed decisions for optimizing the performance of the plurality of PV panels 106.

In an embodiment, the system 102 may be configured to enable real-time monitoring of the solar power plant 104 by continuously tracking the accumulation of the plurality of particles to provide optimized cleaning schedules. Further, the system 102 enhances the efficiency of the solar power plant 104 by minimizing the soiling loss and maintaining optimal PV panel performance. Furthermore, the system 102 may be configured to predict soiling loss based on the deposition rate data and improve the long-term efficiency of the solar power plant 104. Further, the system 102 provides a proactive and data-driven approach to enhance the solar energy production based on the predicted soiling loss. Thus, the predicted soiling loss facilitates in minimizing energy losses, reduces operational costs, and maximizes the overall energy output, which improves the efficiency of the solar power plant 104.

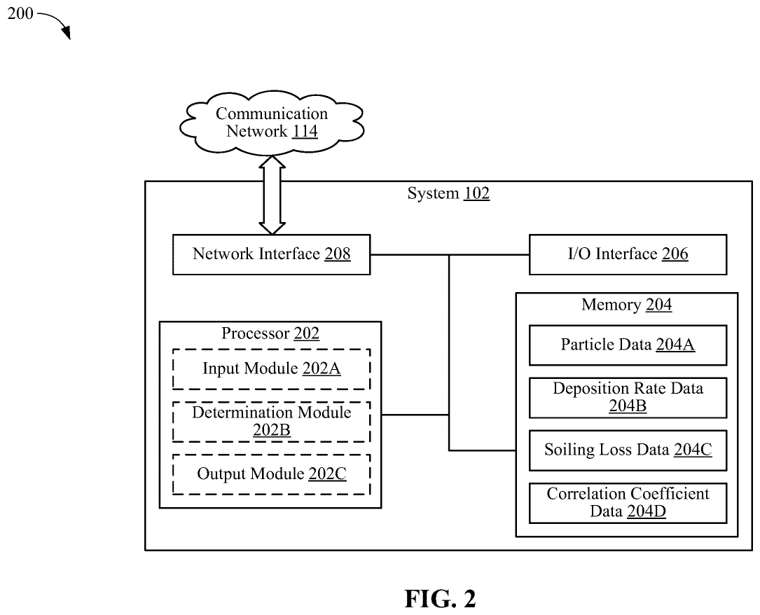

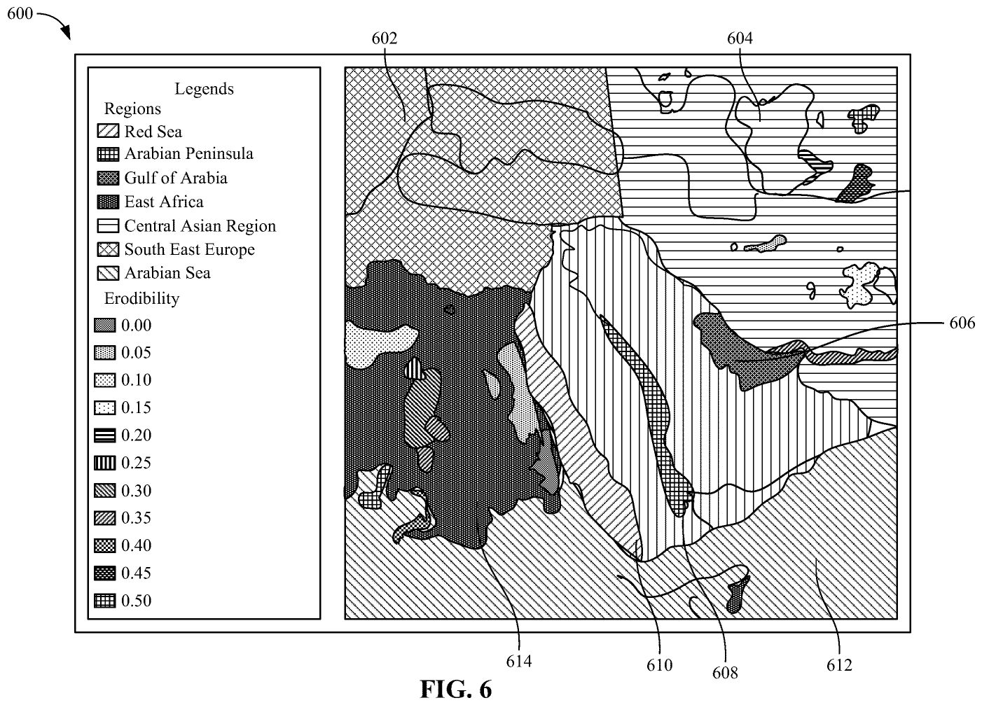

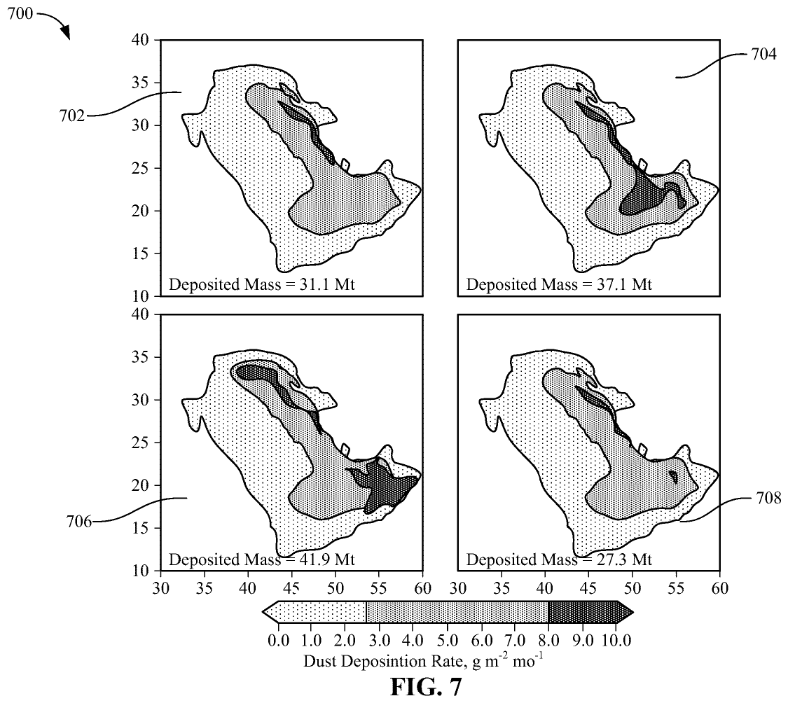

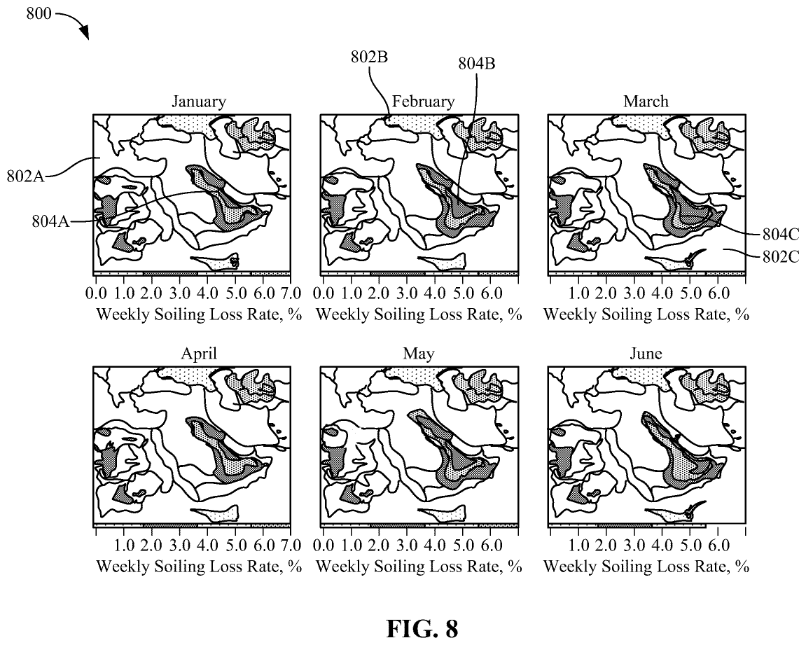

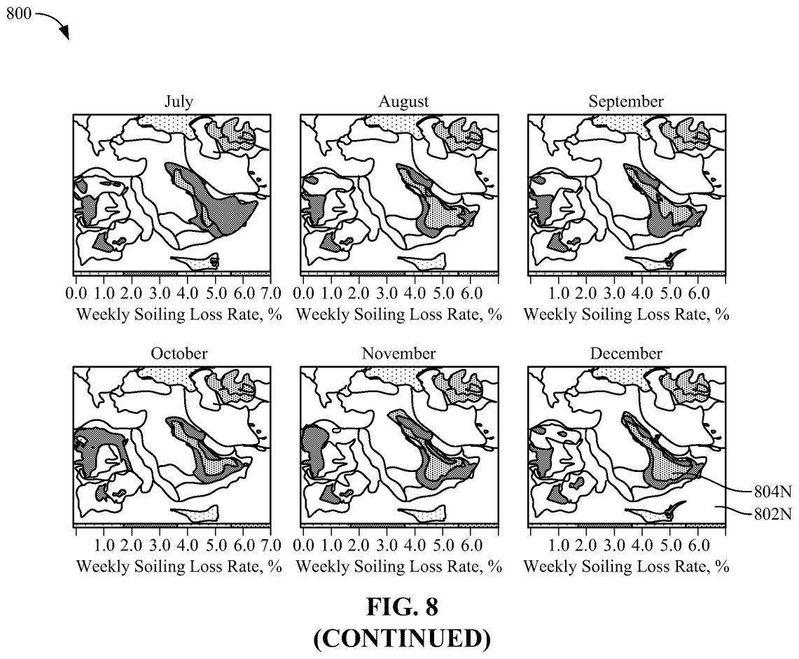

The functions or operations executed by the system 102 are further described in detail in conjunction with, for example, FIG. 2, FIG. 3, FIG. 4, FIG. 5A-5D, FIG. 6, FIG. 7, and FIG. 8.

FIG. 2 illustrates a block diagram 200 of the system 102 of FIG. 1, in accordance with an embodiment of the disclosure. FIG. 2 is explained in conjunction with FIG. 1. The system 102 may include at least one processor 202 (referred to as a processor 202, hereinafter), at least one non-transitory memory 204 (referred to as a memory 204, hereinafter), an input/output (I/O) interface 206, and a network interface 208. The processor 202 may include modules, depicted as an input module 202A, a determination module 202B, and an output module 202C. The processor 202 may be connected to the memory 204 and an I/O interface 206 through wired or wireless connections. Although FIG. 2 shows that the system 102 includes the processor 202, the memory 204, and the I/O interface 206, the disclosure may not be limiting, and the system 102 may include fewer or more components to perform the same or other functions of the system 102. In an embodiment, the input module 202A and the output module 202C may be integrated within the I/O interface 206. In some embodiments, the input module 202A may receive input data (such as user inputs), and the output module 202C may produce outputs via the I/O interface 206.

In accordance with an embodiment, the system 102 may store data that may be generated by the modules of the processor 202 while performing corresponding operations. Alternatively, the system 102 may retrieve the data from the one or more databases 110 associated with the system 102. For example, the data may include particle data 204A, including the particle deposition and the PM10 concentration data associated with the plurality of PV panels 106, deposition rate data 204B, soiling loss data 204C, and correlation coefficient data 204D.

The processor 202 of the system 102 may be configured to retrieve the particle data 204A associated with the plurality of particles from the one or more sensors 108. Further, the system 102 is configured to determine the deposition rate data 204B based on the particle data 204A, which is retrieved. Furthermore, the system 102 is configured to determine the soiling loss data 204C based on the determined deposition rate data 204B. The system 102 is configured to determine correlation coefficient data 204D based on the determined deposition rate data 204B and the determined soiling loss data 204C. The correlation coefficient data 204D may indicate one or more correlation coefficients between the corresponding soiling loss and observational data. The processor 202 may be embodied as one or more hardware processing means such as a coprocessor, a microprocessor, a controller, a digital signal processor (DSP), a processing element with or without an accompanying DSP, or processing circuitry including integrated circuits such as, for example, an ASIC (application-specific integrated circuit), an FPGA (field programmable gate array), a microcontroller unit (MCU), a hardware accelerator, a special-purpose computer chip, or the like. In some embodiments, the processor 202 may include one or more processing cores configured to perform independently. A multi-core processor may enable multiprocessing within a single physical package. Additionally, or alternatively, the processor 202 may include one or more processors configured in tandem via a bus to enable independent execution of instructions, pipelining, and/or multithreading. Additionally, or alternatively, the processor 202 may include one or more processors, which are capable of processing large volumes of workloads and operations to provide support for big data analysis. In an embodiment, the processor 202 may be in communication with the memory 204 via the bus for passing information among components of the system 102.

Further, the software instructions embedded in the processor 202 may specifically configure the processor 202 to perform algorithms or operations described herein when the software instructions are executed. The processor 202 may include a clock, an arithmetic logic unit (ALU), and logic gates configured to support the operations of the processor 202. The network environment, such as 100, may be accessed using the network interface 208 of the system 102. The network interface 208 may provide an interface for accessing various features and data stored in the system 102.

In some embodiments, the processor 202 may be configured to provide Internet-of-Things (IoT) related capabilities to the system 102 disclosed herein. The I/O interface 206 may provide access to various features and data stored in the system 102. By incorporating these IoT-related capabilities, for example, but not limited to include, real-time monitoring and data collection, performance optimization, remote access and control, and security and asset protection by the system 102 to improve the efficiency, reliability, and profitability of the solar energy systems, contributing to the overall growth and adoption of the plurality of PV panels 106. The I/O interface 206 may provide a user interface for communication of the system 102 with the user.

The input module 202A of the processor 202 may be configured to retrieve the particle data 204A associated with the plurality of PV panels 106 of the solar power plant 104. The particle data 204A may include the information related to the accumulation of the plurality of particles on the plurality of PV panels 106.

The determination module 202B of the processor 202 may be configured to determine the particle deposition rate associated with the tilt angles at each time interval. Further, the determination module 202B of the processor 202 may determine the soiling loss associated with each tilt angle of the one or more predefined tilt angles of the plurality of PV panels 106 at each time interval of the plurality of predefined time intervals. Further, the determination module 202B is configured for calculating the average correlation coefficient data based on the deposition rate data 204B and the soiling loss data 204C. Furthermore, the determination module 202B may further determine the soiling loss for the geographical region based on calculated average correlation coefficient data. In an embodiment, the determined soiling loss for the entire geographical region may be used to generate the output (for instance, the one or more soiling map or heatmap) depicting the rate of soiling loss in the plurality of PV panels 106 in the solar power plant 104, or across various PV panels in multiple solar power plants within the geographical region.

The output module 202C of the processor 202 may be configured to render one or more soiling maps generated based on the determined soiling loss for the geographical region of the solar power plant 104. The one or more soiling maps may be rendered on the user device 112 associated with the user 118. The one or more soiling maps may be utilized to predict the rate of soiling loss in the geographical region at the plurality of predefined time intervals. In an exemplary embodiment, the output module 202C may further output the calculated correlation coefficient to the user 118.

The memory 204 of the system 102 may be configured to store the particle data 204A, the deposition rate data 204B, the soiling loss data 204C, and the correlation coefficient data 204D. The memory 204 may be non-transitory and may include, for example, one or more volatile and/or non-volatile memories. For example, the memory 204 may be an electronic storage device (for example, a computer-readable storage medium) including a logical gate configured to store data (for example, bits) that may be retrievable by a machine (for example, a computing device like the processor 202). The memory 204 may be configured to store information, data, content, applications, or software instructions to enable the system 102 to carry out various functions in accordance with an embodiment of the present disclosure. For example, the memory 204 may be configured to buffer input data for processing by the processor 202. As exemplarily illustrated in FIG. 2, the memory 204 may be configured to store software instructions for execution by the processor 202.

In an embodiment, the memory 204 may include at least one of the particle data 204A indicative of the plurality of particles deposited on the plurality of PV panels 106, the PM10 concentration data indicative of the concentration of the PM10 in the atmosphere, the solar irradiance data indicative of the amount of solar radiation incident on the surface of the plurality of PV panels 106, the environmental data indicative of one or more factors that may influence dust deposition and soiling on the PV panel 106. The one or more factors may include, but are not limited to, wind, temperature, humidity, and atmospheric pressure.

The memory 204 may further include dust property data indicative of the characteristics of the plurality of particles, such as, but not limited to, the particle size distribution and a refractive index of the plurality of particles. The memory 204 may further include deposition rate data 204B indicative of the rate of dust deposition on the PV panels 106 for each tilt angle of the one or more predefined tilt angles of the PV panel 106 at each time interval of the plurality of predefined time intervals. The deposition rate data 204B may be determined based on the one or more parameters, which may include, but are not limited to, the orientation of the plurality of PV panels, dust accumulation on the plurality of PV panels, or energy output of the plurality of PV panels. Further, the memory 204 may include the soiling loss data 204C indicative of the soiling loss associated with the PV panels 106 for each tilt angle of the one or more predefined tilt angles of the PV panel 106 at each time interval of the plurality of predefined time intervals. The memory 204 may further store the correlation coefficient data 204D, which includes the one or more correlation coefficients indicative of the amount of PM10 particles that are retained on the PV panels 106. The correlation coefficient data 204D is based on the deposition rate data 204B and the soiling loss data 204C.

In some embodiments, the I/O interface 206 may communicate with the system 102 and display the input or output of the system 102. Further, the I/O interface 206 may include, but not be limited to, a display screen, a keyboard, a mouse, a joystick, a touch screen, touch areas, soft keys, one or more microphones, or a plurality of speakers. In one embodiment, the system 102 may include a user interface circuitry configured to control at least some functions of one or more I/O interface elements, such as a display device and, in some embodiments, a plurality of speakers, a ringer, or one or more microphones. The processor 202 may be configured to control one or more functions of the one or more I/O interface elements through software instructions or firmware stored in the memory 204, which are accessible to the processor 202. The processor 202 may further render the output associated with the correlation coefficient data and the one or more soiling maps via the user interface or the I/O interface 206.

The network interface 208 may include an input interface and an output interface for supporting communications to and from the system 102. The network interface 208 may be any means, such as a device or circuitry embodied in either hardware or a combination of hardware and software that is configured to receive or transmit data to/from a communications device, which is in communication with the system 102. The network interface 208 may include, for example, at least one antenna and supporting hardware or software for enabling communications with a wireless communication network. Additionally, the network interface 208 may include the circuitry to interact with the at least one antenna to cause transmission of signals via the at least one antenna or to handle receipt of signals received via the at least one antenna. In some environments, the network interface 208 may alternatively or additionally support wired communication. As such, for example, the network interface 208 may include a communication modem, hardware, or software for supporting communication via cable, digital subscriber line (DSL), or universal serial bus (USB). In some embodiments, the network interface 208 may enable communication with a cloud-based network to enable deep learning (that may be hosted on the cloud-based network).

FIG. 3 is a diagram 300 that illustrates exemplary operations for the calculation of the correlation coefficient, in accordance with an embodiment of the disclosure. FIG. 3 is explained in conjunction with FIG. 1, FIG. 2, and FIG. 3. The operations for the calculation of the correlation coefficient and output of the correlation coefficient data 204D for the PV panel 106 may start at 302.

The present disclosure discloses that the system 102 may be configured for calculating the soiling loss due to the accumulation of the plurality of particles on the solar power plant 104. The system 102 may include the one or more sensors 108 associated with the plurality of PV panels 106, which are placed at one or more tilt angles, such as, but not limited to, 0°, −45°, −15°, 15°, or 45° along the east-west orientation. Further, the placement of the one or more sensors 108 at the one or more tilt angles maximizes the amount of solar radiation captured by the plurality of PV panels 106 throughout the day. Therefore, the system 102 may be configured to significantly improve the efficiency of the energy production based on the placement of the one or more sensors 108 on the plurality of PV panels 106. Furthermore, the system 102 includes a single-axis tracker system that can be configured to enable and track movements of the one or more sensors 108 associated with the plurality of PV panels 106.

In addition to the one or more tilt angles, the one or more sensors 108 are positioned at an exemplary angle that may be, but is not limited to, approximately 25° tilt facing south, mimicking an optimal fixed-tilt orientation for the geographical region. The system 102 may further include the sensor data 116, which includes the accumulation of the plurality of particles (for example, the dust particles and the particulate matter having a size of 10 micrometers (μm) or less). The sensor data 116 may be collected for the plurality of predefined time intervals, including an hourly time interval, a daily time interval, a weekly time interval, or a monthly time interval. The system 102 may further calculate the deposition rate data 204B for the one or more tilt angles at each time interval. By calculating the deposition rate data 204B for the one or more tilt angles at each time interval, the system 102 may provide valuable insights into a relationship between one or more parameters, which may include, but are not limited to, panel orientation, dust accumulation, or energy output. For example, the system 102 may identify optimal angles for a specific condition, which includes, by not limited to, a specific time of a day, a specific weather condition, and a specific season. A first PV panel 106A may be tilted at a 15° angle during sunrise and may capture a greater amount of direct radiation than the first PV panel 106A tilted at a 10° angle. During midday, the first PV panel 106A, placed at 0° angle, might be the optimal position to capture the greatest amount of direct radiation. Further, the first PV panel 106A, despite being at an optimal angle (e.g., 0° angle), consistently underperforms compared to other panels at a similar angle, which could indicate the accumulation of the plurality of particles. Furthermore, the system 102 may calculate the soiling loss based on the plurality of particles deposited on the PV panel 106 for the one or more tilt angles at each of the plurality of predefined time intervals.

In addition, the system 102 may calculate the correlation coefficient to account for environmental factors such as the effects of wind on the deposition of the plurality of particles. The correlation coefficient may represent a ratio of the soiling loss to the particle deposition rate on a daily interval, a weekly interval, or a monthly interval. Based on the correlation coefficient, the system 102 effectively evaluates the influence of the wind and atmospheric humidity on dust accumulation on the PV panels 106 and the subsequent impact on energy production. The correlation coefficient helps to distinguish between the plurality of particles that may be deposited on the PV panel 106 and a subset of particles that remain as a fraction of the plurality of particles due to blowing wind. The system 102 may further calculate an average of the correlation coefficients calculated on at least one of the daily interval, the monthly interval, or the weekly interval, for each of the tilt angles to determine the soiling loss for the geographical region. Additionally, the daily deposition data, the monthly deposition data, and the weekly deposition data are averaged and scaled to the weekly deposition using the PM10 concentration data, which provides an accurate estimation of the plurality of particles that may be accumulated on the plurality of PV panels 106.

In an embodiment, the system 102 may leverage integration of environmental data and spatial analysis to enhance the precision of soiling loss assessments. Thus, the system 102 enables real-time monitoring and predictive modelling of soiling conditions by incorporating the influence of local weather patterns and pollution levels.

One of the key advantages of the system 102 is the ability to precisely determine the soiling loss, which significantly impacts energy production. The proactive approach of the system 102 ensures that the solar power plant 104 operates at maximum efficiency, thereby minimizing the financial impact of the soiling losses.

In an embodiment, a designated site may be established for continuous hourly observations of soiling rates. Further, the designated site may be configurable to ensure representative measurements across varying time intervals, such as daily, weekly, or monthly.

In another exemplary embodiment, the pre-determined area may be located within the pre-determined region. Further, in the pre-determined area, an aluminium structure may be constructed to support the plurality of PV panels 106. The aluminium structure may be designed for the plurality of PV panels 106 to be mounted at different tilt angles, such as, but not limited to, 0°, −45°, −15°, 15°, or 45° along an east-west orientation. The one or more sensors 108 may be associated with the set of samples mounted on the aluminium structure. The configuration may be crucial for evaluating soiling effects on the single-axis tracker systems. In an exemplary embodiment, the single-axis tracker systems may incorporate a type of solar tracking technology designed to optimize the performance of the PV panels 106 by adjusting the orientation associated with the PV panels 106 to follow the sun across the sky. Further, the system 102 may be configured to perform one or more operations to calculate the correlation coefficient and generate the soiling map that is indicative of soiling loss in the pre-determined region.

At 302, the system 102 may be configured to receive the sensor data 116 from the one or more sensors 108 coupled to the plurality of PV panels 106. Further, the system 102 may be configured to retrieve time interval data associated with a particular prediction time interval. The time interval data relates to the recorded or measured value of the accumulation of the plurality of particles within a particular time window. For example, time interval data depicts the accumulation of the plurality of particles over an hourly interval, a daily interval, a weekly interval, and a monthly interval.

In another embodiment, the system 102 may be configured to retrieve energy parameter data associated with the plurality of PV panels 106. The energy parameter data may refer to measured values to define the performance of the plurality of PV panels 106 based on one or more parameters of the solar power plant 104. The one or more parameters may include, but are not limited to, power output, voltage data, current data, the soiling loss data, temperature data, and the like.

In another embodiment, the system 102 may be configured to generate predicted energy output data associated with the particular prediction time interval based on the energy parameter data and the soiling loss prediction data. The predicted energy output data may be utilized to optimize power generation, performance monitoring, and fault detection of the solar power plant 104, and estimate future energy output based on the predicted soiling loss.

In another embodiment, the system 102 may be configured to receive the sensor data 116 associated with the accumulation of the plurality of particles on the plurality of PV panels 106 and the environmental data. The environmental data associated with the plurality of PV panels 106 includes at least one of wind data, humidity data, atmospheric pressure data, or temperature data.

At 304, the deposition rate determination operation may be executed. The system 102 may determine the deposition rate associated with the accumulation of the plurality of particles on the plurality of PV panels 106 based on the sensor data 116. The deposition rate data 204B indicates the particle deposition rate for each tilt angle of one or more predefined tilt angles of the plurality of PV panels 106 at each time interval of the plurality of predefined time intervals. The deposition rate data 204B may be important for understanding the impact of the accumulation of dust on the performance and efficiency of the plurality of PV panels 106. In an embodiment, the system 102 may retrieve particle deposition data of the plurality of particles (the PM10 having a size of 10 micrometers (μm) or lesser) at the plurality of predefined time intervals which may include, but not limited to, the hourly interval, the daily interval, the weekly interval, or the monthly interval. Further, the system 102 may measure the amount of the plurality of particles collected on the surface of the plurality of PV panels 106 over each specified time interval of the plurality of predefined time intervals. The system 102 may retrieve the particle deposition data from the one or more sensors 108 on the hourly interval. Each sensor of the one or more sensors 108 records the amount of dust accumulated on each PV panel of the plurality of PV panels 106 during the hourly interval. Further, the system 102 may retrieve the data associated with the PM10 concentration data from a PM10 sensor on the hourly interval. The system 102 may further process the received particle deposition data. Further, the system 102 stores the processed particle deposition data in the one or more databases 110. Further, the system 102 may determine the particle deposition rate by dividing the amount of dust accumulated on the surface of the plurality of PV panels 106 based on a predefined period. The predefined period represents the duration during which the plurality of particles has been accumulating on the plurality of PV panels 106.

In an exemplary embodiment, the system 102 may determine measurements associated with the PM10 concentration data using the one or more sensors 108 from an air quality monitoring station (such as the ThermoFisher® air quality monitoring station). The one or more sensors 108 may be designed to measure the particulate matter (PM10) concentration data, which consists of fine dust and the plurality of particles with the diameter of less than 10 micrometers. The sensor data 116 from the one or more sensors 108 may be integrated with environmental measurements to estimate the local aerosol deposition rate associated with the plurality of particles and understand the impact of the estimated local aerosol deposition rate on the PV soiling rates.

At 306, a soiling loss determination operation may be executed. The system 102 may be configured to determine the soiling loss associated with the plurality of PV panels 106 based on the deposition rate data 204B. The system 102 determines the soiling loss for each tilt angle of the one or more predefined tilt angles of the plurality of PV panels 106 at each time interval of the plurality of predefined time intervals. The soiling loss depends on the predefined tilt angles, as different angles influence the particle deposition rate at various instances, which may be measured over the specific time interval to track the accumulation of particle deposition.

In an embodiment, the system 102 is configured to measure and analyze the accumulation of the plurality of particles on the plurality of PV panels 106 by addressing both soiling losses (SL) and attenuation losses (AL). The soiling losses (SL) and the attenuation losses (AL) may be defined as the relative decrease in solar irradiance due to the presence of the plurality of particles. Specifically, the soiling loss refers to the reduction in the solar energy received by each PV panel of the plurality of PV panels 106 due to deposition of the plurality of particles on the surface of the each PV panel. Further, the AL represents the decrease in solar flux due to the plurality of particles suspended in the atmosphere. Further, the system 102 may calculate the SL and the AL based on the solar irradiance data retrieved from the sensor data 116. The SL and the AL may be determined by the system 102 using the below-mentioned equation (1) and equation (2), respectively.

$$SL = \frac{{E}_{0} - {E}_{S}}{{E}_{0}} \times 100 \% = \frac{Δ {E}_{s}}{{E}_{0}} \times 100 \% \qquad ( 1 )$$

$$AL = \frac{{E}_{0} - {E}_{a}}{{E}_{0}} \times 100 \% = \frac{Δ {E}_{a}}{{E}_{0}} \times 100 \% \qquad ( 2 )$$

where
E₀ corresponds to the daily solar energy received by a clean PV panel of the plurality of PV panels 106 in a clean atmosphere;
Eₛ corresponds to the energy received by a soiled PV panel in the clean atmosphere;
Eₐ corresponds to the energy received by the clean PV panel in a dusty atmosphere;
ΔEₛ corresponds to the decreased solar irradiance due to the difference in soiling; and
ΔEₐ corresponds to the decreased solar irradiance due to the difference in attenuation.

In an exemplary embodiment, the system 102 may be further configured to calculate a total loss (TL) as the sum of the SL and the AL. The total loss (TL) may be calculated as TL−SL+AL.

In an exemplary embodiment, the soiling loss may be calculated based on the amount of dust deposited on the plurality of PV panels 106. The system 102 may utilize the particle data 204A. Further, the particle data 204A may include information about coarse dust, which includes a deposited mass. The system 102 may further calculate the soiling loss per unit of deposited mass using a refractive index of the plurality of particles and a density of the plurality of particles on the PV panels 106. The equation (3) below is used to calculate the soiling loss based on the refractive index.

$$SL = \frac{4 π nxh}{λ} \times 100 \% \qquad ( 3 )$$

where
SL corresponds to the soiling loss;
π is a constant≈3.14159;
n corresponds to a refractive index of the plurality of particles;
x corresponds to a density of the plurality of particles;
h corresponds to a thickness of the deposited dust layer, and
λ corresponds to the wavelength of solar radiation.

For example, if the density of the plurality of particles is 2500 kg/m³ and the refractive index (n)=1.55, and the thickness of the deposited dust layer is determined to be 0.4 μm, the system 102 calculates a soiling loss percentage. For a characteristic wavelength (λ) of 0.55 λm, the soiling loss may be computed to be 4.25%, consistent with observed deposition rate data.

In an exemplary embodiment, the system 102 may calculate the soiling loss by using a Python script. Firstly, the system 102 imports the sensor data 116 from one or more data sources, which include, but are not limited to, Excel files, and weather data from Comma-Separated Values (CSV) files. Further, the system 102 combines the sensor data 116 and the weather data into a single data frame. Further, the system 102 cleans and organizes the sensor data 116 and the weather data based on one or more predefined observations for each tilt angle of the plurality of PV panels 106. The system 102 further applies the observation data, for example, a weekly calibration of the one or more sensors 108 is conducted on every Sunday. Further, the system 102 calculates the SL to accurately quantify the reduction in the solar energy production of solar panels due to the accumulation of the plurality of particles. Furthermore, the system 102 is configured to generate one or more plots based on the calculated SL and export the results into Excel files. The system 102 further collects deposition rate data 204B from the one or more sensors 108 and an air quality station. As the particle data 204A is collected on the monthly interval, the system 102 utilizes the monthly interval of the PM10 concentration data from the air quality station to calculate a daily dust deposition rate and a weekly dust deposition (DDW) rate. In an embodiment, the system 102 employs a discrete procedure to derive the daily dust deposition rate from a monthly dust deposition observations. Then, the dust deposition on a particular day could be calculated as provided in the equation (4) below.

$${DD}_{i} = \frac{DD X {C}_{i}}{\sum {}_{K = 1}^{N} {C}_{K}} \qquad ( 4 )$$

where
Cᵢ corresponds to PM10 concentration value of i^{th} day, where i=1, 2, . . . n;
N corresponds to a number of days in a measurement series (presumably one month);

$$\sum {}_{K = 1}^{N} {C}_{K}$$

corresponds to a summation of PM10 concentration values from 1^{st} day to N^{th} day;
DD corresponds to the accumulation of dust deposition for a chosen monthly period; and
DDᵢ corresponds to the accumulation of dust deposition for a chosen N-day period.

In an exemplary embodiment, the system 102 may perform a first operation of the weekly dust deposition rate. For example, from Sunday to Friday (6 days, without Saturday) to obtain the dust deposition for the period of weekly soiling measurements. The operation may be referred to as the weekly dust deposition rate. The deposition performed on a Saturday must be removed because, according to a measurement protocol, one or more reference control modules and one or more weekly modules may be contaminated on the Saturday at the same rate. Further, to calculate the DDWs, the system 102 retrieves the sensor data 116 from the one or more databases 110, which include, but are not limited to, a measurement database (e.g., MySQL), and reads a monthly dust deposition associated with the plurality of PV panels 106. For calculating the soiling loss, the system 102 obtains the soiling loss data 204C from the one or more data sources, such as but not limited to the Excel file that may be stored in the one or more databases 110. Further, the system 102 computes the relationship between the weekly dust deposition rate and a weekly SL after removing poor-quality data through a quality control procedure (QC). Followed by the QC, the system 102 may be configured to divide the weekly soiling loss (SL) by the DDW for each week.

At 308, the system 102 may be configured to determine the correlation coefficient data 204D for the plurality of PV panels 106 based on the deposition rate data 204B and the soiling loss data 204C. The correlation coefficient data 204D indicates the one or more correlation coefficients between the corresponding soiling loss and the observational data. The observational data may be based on the deposition rate data 204B and the sensor data 116 at corresponding time interval of the plurality of predefined time intervals. In an embodiment, the one or more correlation coefficients may be associated with the specific time interval of the plurality of predefined time intervals, where the one or more correlation coefficients correspond to the ratio of the soiling loss at the specific time interval and the particle deposition rate at the specific time interval. The system 102 may be configured to determine average correlation coefficient data for each tilt angle of the one or more predefined tilt angles of the plurality of PV panels 106, based on the correlation coefficient data 204D. For instance, the average correlation coefficient data pertains to the estimation of energy production in the future based on the predicted soiling loss. Further, the system 102 may be configured to determine regional soiling loss data for a geographical region associated with the plurality of PV panels 106 based on the average correlation coefficient data. For instance, determine the regional soiling loss data that pertains to deriving a regional soiling loss value for the geographical region (a particular region or a pre-determined region, for example, a Gulf Cooperation Council (GCC) region). The regional soiling loss value helps in depicting an energy yield forecasting, which improves the accuracy associated with the prediction of electricity generation over a predefined time frame using the solar power plant 104 in the particular region.

The system 102 may be configured to determine the soiling loss prediction data for the particular prediction time interval for the geographical region based on the regional soiling loss data. The soiling loss prediction data may refer to an estimated reduction in a PV panel's power output due to the dust deposition, which is based on historical data, environmental data, and the observational data. The regional soiling loss data may refer to a reduction in power output measured across the geographical region associated with the plurality of PV panels 106.

In an embodiment, the system 102 may be configured to provide a normalized soiling loss ratio, in % per 1 gram per meter square (g/m²) the particle deposition (not dust accumulated on the surface of the PV panels 106). Further, the system 102 is configured to calculate the correlation coefficient data 204D, as the subset of particles is retained on the surface of each PV panel of the plurality of PV panels 106. Finally, an average soiling loss coefficient (SLN) is obtained based on the observational data and the one or more predefined tilt angles, where the average SLN relates to the dust deposition and the soiling losses.

In another embodiment, the system 102 may be configured to determine the correlation coefficient data 204D for each of the plurality of PV panels 106 based on the deposition rate data 204B for each of the plurality of PV panels 106. Further, the system 102 may be configured to determine average deposition rate data for each tilt angle of the one or more predefined tilt angles of each of the plurality of PV panels 106, based on the corresponding deposition rate data. The system 102 may be configured to determine the regional soiling loss data for the geographical region based on the determined average deposition rate data of each of the plurality of PV panels 106.

In an embodiment, the system 102 utilizes the average correlation coefficient data to estimate the soiling loss over the geographical region. The system 102 may define the SLN based on averaging corresponding SLN for each of the plurality of PV panels 106 associated with the one or more predefined tilt angles. Further, assuming that the single-axis tracker system is used in the solar power plant 104 is configured to adjust the tilt angle as each panel of the plurality of PV panels 106 may change the angle during the day. In case, the SLN may provide the normalized soil loss ratio, i.e., the relation between the particle deposition rate and the soiling loss. The system 102 utilized a pre-established correlation coefficient to estimate soiling loss. In another exemplary embodiment, the system 102 may further utilize the determined soiling loss from June 2023 to February 2024 while collecting the hourly PM10 concentration data within the same timeframe to determine the ratio between the soiling loss and dust deposition rates. The system 102 is configured to determine the correlation coefficient by analyzing historical soiling loss data against dust deposition rate (PM10) data to continuously learn and improve estimation accuracy.

The system 102 may further integrate experimental data with modelling efforts. The system 102 may use the deposition rate data 204B to optimize an aerosol size distribution (The aerosol size distribution refers to the distribution of the plurality of particles suspended in air). Further, constrain a Weather Research and Forecasting (WRF)-Chem model's aerosol representation by adapting an Aerosol Optical Depth (AOD) and the observed deposition rate data.

Further, the system 102 may estimate an upper limit of the PV soiling rate by calculating the particle deposition rate. Further, the system 102 may correlate the calculated particle deposition rate with the calculated SL. By using the calculated soiling loss, the system 102 may determine a relationship between the deposition rate data 204B and the soiling loss of the plurality of PV panels 106. The system 102 may effectively measure the impact of the plurality of particles on the solar energy production based on the calculated soiling loss, which provides a valuable insight for optimizing maintenance and performance of the plurality of PV panels 106 in dusty environments.

At 310, the system 102 may be configured to generate one or more soiling maps associated with the plurality of PV panels 106 based on the correlation coefficient data 204D. The system 102 may be configured to generate visual indication data associated with the geographical region based on the soiling loss prediction data for the particular prediction time interval for the geographical region. The visual indication data may be associated with the one or more soiling maps and displays the visual indication data. The visual indication data may include graphical-based representations that suggest a status, a performance, an alert, and the like in the solar power plant 104. The visual indication data may further include, but not be limited to, a soiling level indicator, a sensor-based alert, a visual cue, and a signal indicator.

At 312, the system 102 may be configured to output the one or more soiling maps for the plurality of PV panels 106. The one or more soiling maps represent dust accumulation on the plurality of PV panels 106. In an embodiment, the one or more soiling maps may be used to infer information associated with the plurality of PV panels 106, which may include but not limited to estimated power loss due to dust accumulation in the PV panel 106, soiling distribution patterns in the PV panel 106, efficiency of the PV panel 106, performance of the PV panel 106, and the like.

FIG. 4 is a diagram that illustrates an arrangement of each sensor of the one or more sensors, which are associated with each PV panel of the plurality of PV panels 106, in accordance with an embodiment of the disclosure. FIG. 4 is explained in conjunction with FIG. 1, FIG. 2, and FIG. 3.

FIG. 4 illustrates that the one or more sensors 108 includes the first sensor 108A, the second sensor 108B, a third sensor 108C, and an N^{th} sensor 108N associated with the plurality of PV panels 106 including the first PV panel 106A, the second PV panel 106B, and the nth PV panel 106N, respectively. In an embodiment, the system 102 may be configured to receive the sensor data 116 associated with the accumulation of the plurality of particles on the first PV panel 106A, the second PV panel 106B, and the third PV panel 106C. Each of the first sensor 108A, the second sensor 108B, the third sensor 108C, and the N^{th} sensor 108N is arranged at a predefined tilt angle from the first PV panel 106A, the second PV panel 106B, the third PV panel 106C, and the Nth PV panel 106N, respectively.

In an exemplary embodiment, the first sensor 108A may be configured to measure the solar irradiance to determine the amount of sunlight received, which may help to assess energy conversion efficiency. In another exemplary embodiment, the second sensor 108B may be configured to detect the plurality of accumulated particles on the plurality of PV panels 106 to compute the soiling loss. In another exemplary embodiment, the third sensor 108C may be configured to monitor the temperature of the plurality of PV panels 106 to evaluate thermal effects on efficiency.

In an exemplary embodiment, the first sensor 108A may be associated with the first PV panel 106A, and the second sensor 108B may be associated with the second PV panel 106B. In one scenario, the plurality of PV panels 106 may be installed at 45 degrees relative to a horizontal plane. Further, PM10 particulate matter sensors may be installed within the vicinity of the plurality of PV panels 106 to measure the concentration of the PM10 particulate matter. The PM10 particulate matter sensors may be configured to record the concentration of PM10 particulate matter in ambient air in real-time.

In another embodiment, the system 102 may retrieve the particle data 204A from the one or more databases 110. The system 102 may utilize monthly observational data of the particle data 204A, indicative of the rate of deposition of the plurality of particles on the PV panel 106.

FIG. 5A is a diagram that illustrates a schematic diagram of an arrangement of the one or more sensors 108 associated with the plurality of PV panels in the east-west orientation, in accordance with an embodiment of the disclosure. FIG. 5A is explained in conjunction with FIG. 1, FIG. 2, FIG. 3, and FIG. 4.

FIG. 5A illustrates the one or more sensors 108 associated with the set of PV panels 106 arranged in the east-west orientation setup 502 for maximizing solar energy. Additionally, air quality stations (e.g., OASIS) 504 may measure and monitor concentrations of additional air pollutants in an ambient environment. In an embodiment, the system 102 may include one or more sensors may including the first sensor 108A, the second sensor 108B, up to the N^{th} sensor 108N, which are associated with each PV panel of the set of PV panels 106.

In an embodiment, the first sensor 108A of the one or more sensors 108 is arranged in a first predefined orientation associated with the PV panel 106. The second sensor 108B is arranged in a second predefined orientation associated with the PV panel 106. The PV panel 106 is movable to adjust the tilt angle thereof. The tilt angle of the PV panel 106 is adjusted based on the one or more predefined tilt angles. The one or more PV panels such as the first PV panel 106A, the second PV panel 106B, up to an Nth PV panel 106N are placed at an angle, such as 0°, −45°, −15°, 15°, or 45° along the east-west orientation setup 502. In an embodiment, the first PV panel 106A of the plurality of PV panel 106 is placed at −45°, the second PV panel 106B of the plurality of PV panels 106 is placed at −15°, the third PV panel 106C of the plurality of PV panel 106 is placed horizontally at 0°, the fourth PV panel 106D is placed at 15° and the Nth PV panel 106N of the plurality of PV panel 106 is placed at 45°. The east-west orientation setup 502 refers to a configuration where the PV panels 106 are arranged to face at least one of the east direction or the west direction. The arrangement is particularly beneficial for maximizing solar energy captured during morning and late afternoon when the sun is rising in the east and setting in the west, respectively.

In an embodiment, the one or more sensors 108 include the first sensor 108A, the second sensor 108B, the third sensor 108C, and the Ni sensor 108N. Further, the first sensor 108A is associated with the first PV panel 106A of the plurality of PV panels 106, the second sensor 108B is associated with the second PV panel 106B of the plurality of PV panels 106, the third sensor 108C is associated with the third PV panel 106C of the plurality of PV panels 106, the fourth sensor 108D is associated with the fourth PV panel 106D of the plurality of PV panels 106 and the N^{th} sensor 108N is associated with the Nth PV panel 106N of the set of PV panels 106. In another embodiment, the system 102 may further collect sensor data 116 associated with the plurality of PV panels 106. The sensor data 116 associated with the plurality of PV panels 106 may be related to the deposition of dust and the PM10 particulate matter on the PV panels 106. The sensor data 116 may include, but is not limited to, dust deposition rates, solar irradiance levels, energy production metrics, module temperature, light transmittance, particulate matter observations, humidity and temperature data, wind speed and directions, cleaning, and frequency related data, comparative performance data, and seasonal variations. The sensor data 116 may be collected for the plurality of predefined time intervals, including hourly, daily, weekly, or monthly. Details related to the collection of sensor data 116 based on various intervals are described below in the explanation of FIG. 5C.

FIG. 5B is a diagram that illustrates a schematic diagram of an arrangement of the one or more sensors 108 associated with the plurality of PV panels 106 in the north-south orientation, in accordance with an embodiment of the disclosure. FIG. 5B is explained in conjunction with FIG. 1, FIG. 2, FIG. 3, FIG. 4, and FIG. 5A.

With reference to FIG. 5B, in addition to the one or more sensors 108 placed at one or more predefined tilt angles along a north-south orientation setup 506. For example, the system 102 incorporates the one or more sensors 108 associated with the plurality of PV panels 106, which are positioned at the predefined tilt angle of approximately 25°, facing south. The configuration of the one or more sensors 108 replicates an optimal fixed-tilt orientation for the solar power plant 104 in the geographical region. The south-facing orientation for the solar power plant 104, for example, in a northern hemisphere of a globe, as the geographical region allows for maximum exposure to sunlight throughout the day. The system 102 is configured to receive the sensor data 116 from the one or more sensors 108. Further, the sensor data 116 includes the accumulation of the plurality of particles on the plurality of PV panels 106. The system 102 may be configured to receive the sensor data 116 for each time interval of the plurality of predefined time intervals. Furthermore, the system 102 compares the accumulation of the dust particle and the soiling losses between the single-axis tracker systems and the optimal fixed-tilt orientation, which is set at an optimal predefined tilt angle (e.g., 25°). The sensor data 116 may include measurements from the one or more sensors 108 (e.g., an irradiance sensor, a temperature sensor, a humidity sensor, and the like). The sensor data 116 may be continuously collected from the solar power plant 104 to provide real-time insights pertaining to the environmental conditions and the soiling losses.

FIG. 5C and FIG. 5D, in combination, illustrates a schematic diagram of the arrangement of the one or more tilt angles of the one or more sensors 108 associated with the plurality of PV panels 106, in accordance with an embodiment of the disclosure. FIG. 5C is explained in conjunction with FIG. 1, FIG. 2, FIG. 3, FIG. 4, FIGS. 5A and 5B.

With reference to FIG. 5C, the sensor data 116 associated with the plurality of PV panels 106 may be collected for the plurality of predefined time intervals, including hourly, daily, weekly, or monthly basis. Each tilt angle of the one or more predefined tilt angles is associated with the set of three modules of the first PV panel 106A. As depicted in FIG. 5C, the system 102 may include the set of three modules, including the first PV module 106A1, the second PV module 106A2, and the third PV module 106A3 of the first PV panel 106A, which are arranged at the predefined time interval. For example, the set of three modules includes the first PV module 106A1, the second PV module 106A2, and the third PV module 106A3, where the set of three modules is arranged with the predefined tilt angle of −45°. The first PV module 106A1 may be configured to serve as a reference sample. The second PV module 106A2 may be configured to measure a weekly soiling rate. The third PV module 106A3 is configured for assessing a monthly soiling rate. The set of three modules is equipped with the one or more sensors 108 that enable the collection of the sensor data 116 based on the daily interval, the weekly interval, and the monthly interval. The system 102 is configured to maintain a systematic schedule and/or optimized cleaning schedules for measuring and cleaning the plurality of PV panels 106 to ensure that the soiling data is collected appropriately. The reference module (e.g., the first PV module 106A1) is cleaned daily for each predefined tilt angle. The second PV module 106A2, referred to as the “weekly” soiling module, is cleaned every Sunday, while the third PV module 106A3, referred to as the “monthly” glass module, is cleaned at the beginning of each month.

In an embodiment, the optimized cleaning schedules may include one or more adaptive cleaning strategies based on the environmental data and the dust deposition rate. For instance, the one or more adaptive cleaning strategies enabled on the plurality of PV panels 106 may include, but not be limited to, a dry cleaning mode or a wet cleaning mode based on a temperature and a humidity of the environment of the plurality of PV panels 106.

The soiling loss is defined as the difference in irradiance between a soiled sample and a cleaned sample of the plurality of PV panels 106. The soiling loss measurement quantifies a reduction in solar energy capture due to the accumulation of dirt, dust, and other contaminants on the surface of the PV panels 106, which obstruct sunlight and diminish the efficiency of the plurality of PV panels 106. To ensure reliable results and eliminate potential misinterpretations arising from discrepancies in sensor sensitivity, the one or more sensors 108 are strategically positioned adjacent to one another. Arrangement of the one or more sensors 108 helps to maintain consistency in data collected and enhances accuracy of the soiling loss measurements.

With reference to FIG. 5D, an arrangement of the predefined tilt angle of the one or more sensors 108, which are associated with the plurality of PV panels 106, is illustrated. In an exemplary embodiment, a first set of the one or more sensors 108 includes a first sensor S1, a second sensor S2, and a third sensor S3, which are arranged at the predefined angle (for example, 45°). The first sensor S1 is designated for monitoring the daily cleaning schedule, the second sensor S2 is used for monitoring the weekly cleaning schedule, and the third sensor S3 is designated for monitoring the monthly cleaning schedule.

In the second set of the one or more sensors 108 includes a fourth sensor S4, a fifth sensor S5, and a sixth sensor S6, which are arranged at the predefined angle (for example, 15°). The sixth sensor S6 is assigned for monitoring the daily cleaning schedule, the fifth sensor S5 is used for monitoring the weekly cleaning schedule, and the fourth sensor S4 is designated for monitoring the monthly cleaning schedule. In the third set of the one or more sensors 108 includes a seventh sensor S7, an eighth sensor S8, and a ninth sensor S9, which are arranged at the predefined angle (for example, 0°). The seventh sensor S7 is assigned for monitoring the daily cleaning schedule, the eighth sensor S8 is used for monitoring the weekly cleaning schedule, and the ninth sensor S9 is designated for monitoring the monthly cleaning schedule. In the fourth set of the one or more sensors 108 includes a tenth sensor S10, an eleventh sensor S11, and a twelfth sensor S12, which are arranged at the predefined angle (for example, 15°). The tenth sensor S10 is assigned for monitoring the daily cleaning schedule, the eleventh sensor S11 is used for monitoring the weekly cleaning schedule, and the twelfth sensor S12 is designated for performing the monthly cleaning schedule. In the fifth set, there are three sensors of the one or more sensors 108 includes a thirteenth sensor S13, a fourteenth sensor S14, and a fifteenth sensor S15, which are arranged at the predefined angle (for example −45°) The thirteenth sensor S13 is assigned for monitoring daily cleaning schedule, the fourteenth sensor S14 is used for monitoring weekly cleaning schedule, and the fifteenth sensor S15 is designated for monitoring monthly cleaning schedule.

In an embodiment, the system 102 retrieves the sensor data 116 from the various data sources associated with the plurality of PV panels 106. The sensor data 116, along with the weather data, is merged into a single data frame, organizing the sensor data 116, along with the weather data into a predefined observation interval. By integrating the sensor data 116 from the one or more sensors 108 and weather information collected from Comma-Separated Values (CSV) files, the system 102 may present a complete overview of the environmental conditions associated with each tilt angle of the predefined tilt angles. Further, the system 102 is configured to identify gaps in one or more observation periods. Furthermore, the system 102 employees one or more strategies to identify the gaps in the one or more observation periods. The system 102 performs analysis on the one or more observation periods based on the identified gaps to ensure data integrity and reliability. Further, the system 102 minimizes the impact of missing or erroneous measurements associated with the environmental conditions. For instance, the system 102 is configured to organize the sensor data 116 into 2-hour observation intervals for each tilt angle of the predefined tilt angles, allowing the system 102 to monitor changes in weather patterns over time and across different orientations, providing valuable insights for applications, such as optimizing solar energy production.

FIG. 6 and FIG. 7 collectively illustrate a graphical representation of soiling maps associated with the deposition rate data in the pre-determined region, in accordance with an embodiment of the present disclosure. FIG. 6 and FIG. 7 are explained in conjunction with an embodiment of FIG. 1, FIG. 2, FIG. 3, FIG. 4, FIG. 5A, FIG. 5B, FIG. 5C, and FIG. 5D.

FIG. 6 depicts the soiling map, which indicates the locations of one or more AERONET (Aerosol Robotic Network) stations used in the current study. The dust emission scheme employed in the system 102 may assume that the dust emission mass flux, Fp (μg m⁻²s⁻¹) in each dust-bin p=1, 2, . . . , 5 may be defined by the relation given in equation (5) below.

$${F}_{p} = \{ \begin{matrix}{CS}_{sp} U {}_{10 m}^{2} ( {u}_{10 m} - {u}_{t} ) , \vert {u}_{10 m} > {u}_{t} \\ 0 , \vert {u}_{10 m} < {u}_{t}\end{matrix} \qquad ( 5 )$$

where
c corresponds to a spatially uniform factor with a dimension of [μg s²m⁻⁵];
s corresponds to a spatially varying dust source function, which is dimensionless;
U₁₀ₘ² corresponds to a horizontal wind speed at 10 meters (m) above ground level;
uₜ corresponds to a threshold velocity, which depends on a particle size and a surface wetness; and
sp corresponds to a fraction of dust mass emitted into the dust-bin p, and Σ sp=1, where sp (p=1,2,3,4,5) defines the aerosol size distribution of an emitted dust.

In an embodiment, the spatially uniform factor may control a magnitude of dust emission flux, which refers to a rate at which the plurality of particles is lifted from the surface of the plurality of PV panels 106 and enters the atmosphere. Further, the spatially varying dust source function may characterize a spatial distribution of the dust emission sources (0<s<1). A value of s closer to 1 may indicate the pre-determined area with a greater potential for the accumulation of the plurality of dust particles, while the pre-determined area with the value of s closer to 0 may indicate minimal accumulation of the plurality of dust particles.

The system 102 may further tune the dust emission flux to fit the aerosol optical depth (AOD) from the one or more AERONET stations. For instance, the factor C may be adjusted to obtain the best agreement between simulated and observed AOD with AERONET sites (C=0.525). The system 102 may further tune sp to better reproduce the Aerosol Volume Size Distribution (PSD) provided by an AERONET inversion algorithm. The AERONET inversion algorithm is a computational method that may be used to retrieve aerosol properties from the measurements taken by AERONET sunphotometers.

In an exemplary embodiment, as shown in FIG. 6, the soiling map of the pre-determined region is depicted. Further, the deposition rate data 204B may include one or more levels, each corresponding to the one or more sub-regions within the pre-determined region of the solar power plant 104. For example, the pre-determined region of the solar power plant 104 includes a first pre-determined region 602, a second pre-determined region 604, a third pre-determined region 606, a fourth pre-determined region 608, a fifth pre-determined region 610, a sixth pre-determined region 612, and a seventh pre-determined region 614. The one or more levels of an erodibility range may include at least one of a high level of erodibility, ranging on a scale between 0.30-0.50, a medium level of erodibility on the scale ranging between 0.20-0.30, and a low level of erodibility on the scale ranging between 0.0-0.20. The erodibility range refers to a spectrum range associated with the detachment of the plurality of particles in the pre-determined region of the solar power plant 104, where the plurality of particles may be carried away by natural forces which including wind or water. For instance, the second pre-determined region 604 depicts the dust deposition rate at the high level of erodibility.

The pre-determined region may be associated with an erodibility range. For example, a Red Sea region may be the first pre-determined region 602 on the high level of erodibility (e.g., between 0.30-0.50), an Arabian Peninsula region may be the second pre-determined region 604 on the high level of erodibility, and a Gulf of Arabia region may be the third pre-determined region 606 on the moderate level of erodibility (e.g., between 0.20-0.40). An East Africa region may be the fourth pre-determined region 608 on the moderate level of erodibility (e.g., between 0.15-0.40). A Central Asian region may be the fifth pre-determined region 610 on the high level of erodibility (e.g., between 0.40-0.50). A Southeast Europe region may be the sixth pre-determined region 612 on the low level of erodibility (e.g., between 0.05-0.20). In an embodiment, the high level of deposition rate may result in the high level of soiling loss.

Further, FIG. 7 depicts the deposition rate data 204B in the pre-determined region at the plurality of predefined time intervals. The deposition rate data 204B refers to the measurement of the accumulation of the dust particles on the surface of the plurality of PV panels 106 in the pre-determined region at the plurality of predefined time intervals. The system 102 is configured to regularly collect the deposition rate data 204B within the pre-determined region. The deposition rate data 204B is acquired at the plurality of predefined time intervals. For example, FIG. 7 shows the deposition rate data 204B collected month-wise, where a first region 702 represents the first pre-determined region 602 in a first quarter of a year, a second region 704 represents the second pre-determined region 604 in a second quarter of the year, a third region 706 represents the third pre-determined region 606 in a third quarter of the year, and a fourth region 708 depicts the fourth pre-determined region 608 in a fourth quarter of the year. The deposition rate data 204B can be measured using a deposited mass. The first region 702 shows first deposition rate data in the first pre-determined region 602 during the first quarter of the year (for example, from the month of December to February), resulting in a first deposited mass of 31.1 metric tons (Mt). The second region 704 shows second deposition rate data in the second pre-determined region 604 during the second quarter of the year (for example, from March to May) resulting in a second deposited mass of 37.1 Mt. The third region 706 shows third deposition rate data in the third pre-determined region 606 during the third quarter of the year (for example, from June to August) resulting in a third deposited mass of 41.9 Mt. The fourth region 708 shows fourth deposition rate data in the fourth pre-determined region 608 during the fourth quarter of the year (for example, from September to November) resulting in a fourth deposited mass of 27.3 Mt.

In an exemplary embodiment, the soiling loss of the plurality of PV panels 106 is rendered on a Graphical User Interface (GUI) associated with the user device 112. The GUI may present the soiling loss in various formats, such as charts, soiling maps, or alerts, all viewable on the user device 112. For instance, the system 102 renders the soiling map that shows that the dust deposition rate in the one or more sub-regions within the pre-determined region is lower in December, January, and February as compared to the deposition rate in the one or more sub-regions within the pre-determined region in March, April, and May. By utilizing the deposition rate data 204B, the system 102 may determine the rate of soiling loss in the one or more sub-regions of the pre-determined region. Further, the system 102 may utilize the determined rate of soiling loss and the determined deposition rate to predict the rate of soiling loss in the pre-determined region for future instances.

FIG. 8 illustrates a graphical representation of soiling maps associated with the rate of soiling loss in the pre-determined region, in accordance with an embodiment of the present disclosure. FIG. 8 is explained in conjunction with an embodiment of FIG. 1, FIG. 2, FIG. 3, FIG. 4, FIG. 5A, FIG. 5B, FIG. 5C, FIG. 5D, FIG. 6, and FIG. 7.

In an exemplary embodiment, FIG. 8 represents a weekly soiling loss rate, %, which depicts a percentage of solar energy production that may be lost by the solar power plant 104 over one year due to the accumulation of the plurality of particles on the surface of the plurality of PV panels 106. In a first instance, in the month of January, a first soiling map 802A represents the rate of soiling loss in the first pre-determined region (e.g., the first pre-determined region 602). In a second instance, in the month of February, a second soiling map 802B represents the rate of soiling loss in the second pre-determined region (e.g., the second pre-determined region 604). In a third instance, in the month of March, a third soiling map 802C represents the rate of soiling loss in the third pre-determined region (e.g., the third pre-determined region 606). In a twelfth instance, in December, a N^{th} soiling map is indicative of the rate of soiling loss in a N^{th} pre-determined region. Further, 804A, 804B, 804C, and 804N may correspond to a first location, a second location, a third location, and an N^{th} location, respectively, in the pre-determined region at a predefined period.

For example, as shown in FIG. 8, the rate of soiling loss in the first location 804A in January may be less than the rate of soiling loss in the third location during March. The determined deposition rate in January is less than the deposition rate in March. Similarly, the system 102 may predict the rate of soiling loss in the pre-determined region for the predefined period, for example, one year. The system 102 may further render the soiling map associated with the rate of soiling loss on the user device 112.

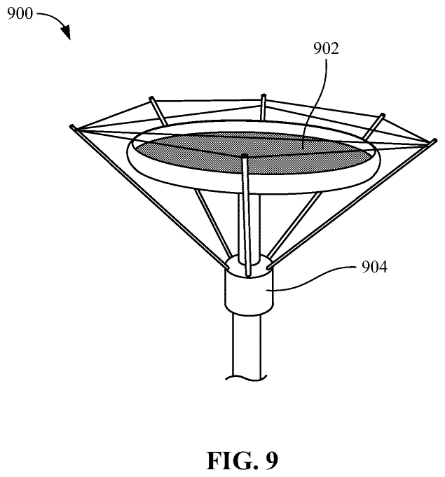

FIG. 9 illustrates a schematic diagram of the passive dust sampler, in accordance with an embodiment of the disclosure. FIG. 9 is explained in conjunction with FIG. 1, FIG. 2, FIG. 3, FIG. 4, FIG. 5A, FIG. 5B, FIG. 5C, FIG. 5D, FIG. 6, FIG. 7, and FIG. 8.

With reference to FIG. 9, a dust sampler 900 may be designed to measure the amount of deposited dust by collecting and settling dust over time, for example, every month. For instance, the dust sampler 900 features a sponge layer 902 positioned over a “frisbee plate” made of an aluminum framework 904 to capture dust, which is subsequently washed down with distilled water on the monthly interval. After washing, the dust sampler 900 may undergo a lyophilization process to eliminate moisture, and ensure accurate weight of the plurality of the plurality of particles. The collection of the plurality of particles is analyzed using an X-ray diffractometry (XRD) technique. The XRD technique provides detailed insights into a crystalline structure of the plurality of particles. Additionally, a particle size distribution within the dust sampler 900 may be assessed by the system 102 using a Malvern® Mastersizer 3000 Laser Diffraction Particle Size Analyzer (LPSA), which utilizes laser diffraction to measure the size of particles in the dust sampler 900. Since the LPSA is cost-effective and requires no power supply, the LPSA may function as a passive dust sampling approach, which enables the collection of dust samples without the assistance of an active air sampling equipment.

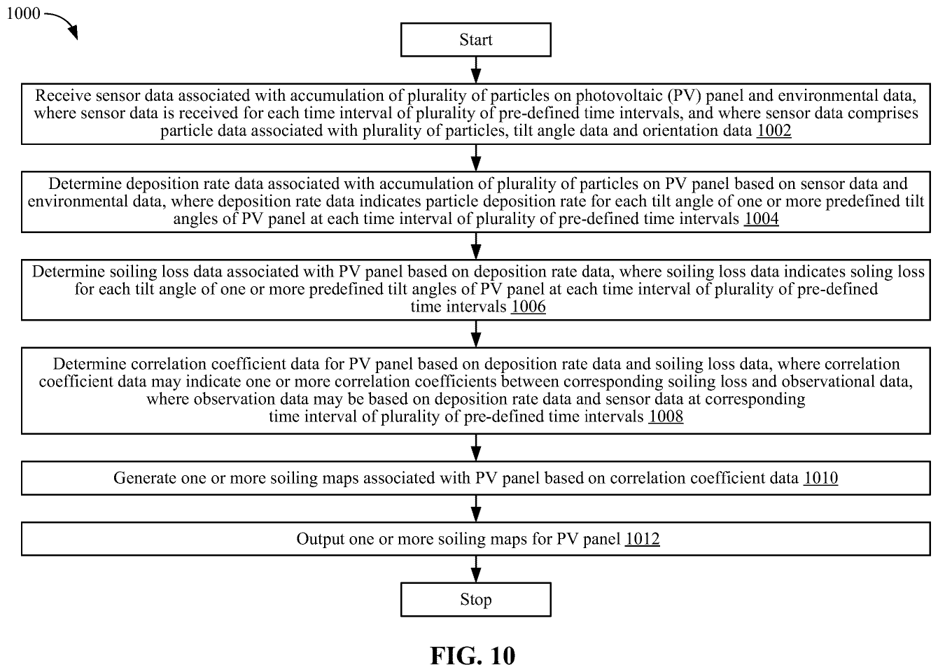

FIG. 10 illustrates a flowchart 1000 of an exemplary method for determining solar photovoltaic soiling loss, in accordance with an embodiment of the disclosure. FIG. 10 is explained in conjunction with elements from FIG. 1, FIG. 2, FIG. 3, FIG. 4, FIG. 5A, FIG. 5B, FIG. 5C, FIG. 5D, FIG. 6, FIG. 7, FIG. 8, and FIG. 9. The operations of the exemplary method may be executed by any computing system, for example, by the system 102 of FIG. 1 or the processor 202 of FIG. 2. The operations of the flowchart 1000 may start at 1002.

At 1002, the sensor data 116 associated with the accumulation of the plurality of particles on the PV panel 106 may be received. Further, the environmental data associated with the PV panel 106 may be received. Further, the sensor data 116 may be received for each time interval of a plurality of predefined time intervals, and the sensor data 116 may include particle data associated with the plurality of particles, tilt angle data, and orientation data. In an embodiment, the system 102 may be configured to receive the sensor data 116 is associated with the accumulation of the plurality of particles on the PV panel 106 and environmental data. The sensor data 116 may be received for each time interval of a plurality of predefined time intervals. The sensor data 116 may include particle data associated with the plurality of particles, tilt angle data, and orientation data. Details about the first information retrieval are provided in FIG. 1, FIG. 2, and FIG. 3.

At 1004, the deposition rate data 204B associated with the accumulation of the plurality of particles on the PV panel 106 based on the sensor data 116 and the environmental data may be determined. The deposition rate data 204B may indicate a particle deposition rate for each tilt angle of one or more predefined tilt angles of the PV panel 106 at each time interval of the plurality of predefined time intervals. The deposition rate data 204B may be important for understanding the impact of dust on the performance and efficiency of the plurality of PV panels 106. In an embodiment, the system 102 may be configured to determine the deposition rate data 204B associated with the accumulation of the plurality of particles on the PV panel 106 based on the sensor data 116 and the environmental data. The deposition rate data 204B may indicate a particle deposition rate for each tilt angle of one or more predefined tilt angles of the PV panel 106 at each time interval of the plurality of predefined time intervals. Details about the first information retrieval are provided in FIG. 2 and FIG. 3.

At 1006, the soiling loss data 204C associated with the PV panel 106 based on the deposition rate data may be determined. The soiling loss data 204C may indicate a soiling loss for each tilt angle of the one or more predefined tilt angles of the PV panel 106 at each time interval of the plurality of predefined time intervals. In an embodiment, the system 102 may be configured to determine soiling loss data 204C associated with plurality of the PV panels 106 based on the deposition rate data 204B. The soiling loss data 204C indicates a soiling loss for each tilt angle of the one or more predefined tilt angles of the PV panel at each time interval of the plurality of predefined time intervals. Details about the first information retrieval are provided in FIG. 2 and FIG. 3.

At 1008, the correlation coefficient data 204D for the PV panel 106 based on the deposition rate data and the soiling loss data 204C may be determined. The correlation coefficient data 204D may indicate one or more correlation coefficients between the corresponding soiling loss and observational data. The observational data may be based on the deposition rate data 204B and the sensor data 116 at corresponding time intervals of the plurality of predefined time intervals. In an embodiment, the system 102 may be configured to determine the correlation coefficient data 204D for the PV panel 106 based on the deposition rate data and the soiling loss data 204C. The correlation coefficient data 204D may indicate one or more correlation coefficients between the corresponding soiling loss and observational data. The observational data may be based on the deposition rate data 204B and the sensor data 116 at corresponding time intervals of the plurality of predefined time intervals. Details about the first information retrieval are provided in FIG. 2 and FIG. 3.

At 1010, the one or more soiling maps associated with the PV panel 106 may be generated based on the correlation coefficient data 204D. The system 102 may be configured to generate visual indication data associated with the geographical region based on the soiling loss prediction data for the particular prediction time interval for the geographical region. The visual indication data is associated with the one or more soiling maps. In an embodiment, the system 102 may be configured to generate the one or more soiling maps associated with the plurality of PV panels 106 based on the correlation coefficient data 204D. Details about the first information retrieval are provided in FIG. 2, FIG. 3, FIG. 6, FIG. 7, and FIG. 8.

At 1012, the one or more soiling maps for the PV panel 106 may be provided as the output. The one or more soiling maps represent dust accumulation on the PV panel 106. In an embodiment, the one or more soiling maps may be used to infer information associated with the PV panel 106, which may include but not limited to estimated power loss due to dust accumulation, soiling distribution patterns, efficiency of the PV panel 106, performance of the PV panel 106, and the like. In an embodiment, the system 102 may be configured to output the one or more soiling maps for the PV panel 106. Details about the first information retrieval are provided in FIG. 2, FIG. 3, FIG. 6, FIG. 7, and FIG. 8.

Accordingly, blocks of the flowchart 1000 support combinations of means for performing the specified functions and combinations of operations for performing the specified functions. It will also be understood that one or more blocks of the flowchart 1000 can be implemented by special-purpose hardware-based computer systems that perform the specified functions, or combinations of special-purpose hardware and computer instructions.

Alternatively, the system 102 may include means for performing each of the operations described above. In this regard, according to an example embodiment, examples of means for performing operations may include, for example, the processor 202 and/or a device or circuit for executing the computer program instructions or executing an algorithm for processing information as described above.

Many modifications and other embodiments of the inventions set forth herein will come to mind to one skilled in the art to which these inventions pertain, having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the invention. In this regard, for example, different combinations of reactants and/or functions than those explicitly described above are also contemplated. Although specific terms are employed herein, they are used in a generic and descriptive sense only and not for purposes of limitation.

What is claimed:

1. A system for determining soiling loss comprising:
one or more processors; and
a memory coupled to the one or more processors, wherein the memory stores instructions, which when executed, causes the one or more processors to:
receive sensor data associated with an accumulation of a plurality of particles on a photovoltaic (PV) panel and environmental data associated with the PV panel, wherein the sensor data is received for each time interval of a plurality of predefined time intervals, and wherein the sensor data comprises particle data associated with the plurality of particles, tilt angle data and orientation data;
determine deposition rate data associated with the accumulation of the plurality of particles on the PV panel based on the sensor data and the environmental data, wherein the deposition rate data indicates a particle deposition rate for each tilt angle of one or more predefined tilt angles of the PV panel at each time interval of the plurality of predefined time intervals;
determine soiling loss data associated with the PV panel based on the deposition rate data, wherein the soiling loss data indicates a soiling loss for each tilt angle of the one or more predefined tilt angles of the PV panel at each time interval of the plurality of predefined time intervals;
determine correlation coefficient data for the PV panel based on the deposition rate data and the soiling loss data, wherein the correlation coefficient data indicates one or more correlation coefficients between the corresponding soiling loss and observational data, and wherein the observational data is based on the deposition rate data and the sensor data at corresponding time interval of the plurality of predefined time intervals;
generate one or more soiling maps associated with the PV panel based on the correlation coefficient data; and
output the one or more soiling maps for the PV panel.

2. The system of claim 1, wherein the one or more processors are further configured to:
receive time interval data associated with a particular prediction time interval, wherein the particular prediction time interval is associated with at least one time interval of the plurality of predefined time intervals; and
determine soiling loss prediction data for the particular prediction time interval based on the time interval data and the correlation coefficient data.

3. The system of claim 2, wherein the one or more processors are further configured to:
retrieve energy parameter data associated with the PV panel; and
generate predicted energy output data associated with the particular prediction time interval based on the energy parameter data and the soiling loss prediction data.

4. The system of claim 2, wherein the one or more processors are further configured to:
determine average correlation coefficient data for each tilt angle of the one or more predefined tilt angles of the PV panel, based on the correlation coefficient data;
determine regional soiling loss data for a geographical region associated the PV panel based on the average correlation coefficient data; and
determine the soiling loss prediction data for the particular prediction time interval for the geographical region based on the regional soiling loss data.

5. The system of claim 4, wherein the PV panel is associated with a plurality of PV panels of a solar power plant, and wherein the one or more processors are further configured to:
determine correlation coefficient data for each of the plurality of PV panels based on the deposition rate data for each of the plurality of PV panels;
determine average deposition rate data for each tilt angle of the one or more predefined tilt angles of each of the plurality of PV panels, based on the corresponding determine deposition rate data; and
determine the regional soiling loss data for the geographical region based on the average deposition rate data of each of the plurality of PV panels.

6. The system of claim 4, wherein the one or more processors are further configured to:
generate visual indication data associated with the geographical region based on the soiling loss prediction data for the particular prediction time interval for the geographical region, wherein the visual indication data is associated with the one or more soiling maps; and
cause to display the one or more soiling maps based on the visual indication data.

7. The system of claim 1, wherein the environmental data comprises at least one of wind data, humidity data, atmospheric pressure data, or temperature data.

8. The system of claim 1, wherein the one or more processors are further configured to:
receive the sensor data associated with the accumulation of the plurality of particles from one or more sensors associated with the PV panel, wherein each of the one or more sensors is arranged at a corresponding angle from the PV panel.

9. The system of claim 8, wherein a first set of sensors of the one or more sensors is arranged in a first predefined orientation associated with the PV panel, and wherein a second set of sensors is arranged in a second predefined orientation associated with the PV panel.

10. The system of claim 1, wherein the PV panel is movable to adjust a tilt angle thereof, and wherein the tilt angle of the PV panel is adjusted based on the one or more predefined tilt angles.

11. The system of claim 1, wherein the correlation coefficient associated with a specific time interval of the plurality of predefined time intervals corresponds to a ratio of the soiling loss at the specific time interval and the particle deposition rate at the specific time interval.

12. The system of claim 1, wherein each of the plurality of particles has a diameter lesser than or equal to 10 micrometers.

13. The system of claim 1, wherein the sensor data further comprises solar irradiance data of the PV panel, energy production metric data of the PV panel, module temperature data of the PV panel, or light transmittance data of the PV panel.

14. A method comprising:
receiving, by a system, sensor data associated with an accumulation of a plurality of particles on a photovoltaic (PV) panel and environmental data associated with the PV panel, wherein the sensor data is received for each time interval of a plurality of predefined time intervals, and wherein the sensor data comprises particle data associated with the plurality of particles, tilt angle data and orientation data;
determining, by the system, deposition rate data associated with the accumulation of the plurality of particles on the PV panel based on the sensor data and the environmental data, wherein the deposition rate data indicates a particle deposition rate for each tilt angle of one or more predefined tilt angles of the PV panel at each time interval of the plurality of predefined time intervals;
determining, by the system, soiling loss data associated with the PV panel based on the deposition rate data, wherein the soiling loss data indicates a soiling loss for each tilt angle of the one or more predefined tilt angles of the PV panel at each time interval of the plurality of predefined time intervals;
determining, by the system, correlation coefficient data for the PV panel based on the deposition rate data and the soiling loss data, wherein the correlation coefficient data indicates one or more correlation coefficients between the corresponding soiling loss and observational data, and wherein the observational data is based on the deposition rate data and the sensor data at corresponding time interval of the plurality of predefined time intervals;
generating, by the system, one or more soiling maps associated with the PV panel based on the correlation coefficient data; and
outputting, by the system, the one or more soiling maps for the PV panel.

15. The method of claim 14, wherein further comprising:
receiving, by the system, time interval data associated with a particular prediction time interval, wherein the particular prediction time interval is associated with at least one time interval of the plurality of predefined time intervals; and
determining, by the system, soiling loss prediction data for the particular prediction time interval based on the time interval data and the correlation coefficient data.

16. The method of claim 15, wherein further comprising:
retrieving, by the system, energy parameter data associated with the PV panel; and
generating, by the system, predicted energy output data associated with the particular prediction time interval based on the energy parameter data and the soiling loss prediction data.

17. The method of claim 14, wherein further comprising:
receiving, by the system, the sensor data associated with the accumulation of the plurality of particles from one or more sensors associated with the PV panel, wherein each of the one or more sensors is arranged at a corresponding angle from the PV panel.

18. The method of claim 17, wherein a first set of sensors of the one or more sensors is arranged in a first predefined orientation associated with the PV panel, and wherein a second set of sensors is arranged in a second predefined orientation.

19. The method of claim 14, wherein the PV panel is movable to adjust a tilt angle thereof, and wherein the tilt angle of the PV panel is adjusted based on the one or more predefined tilt angles.

20. A computer programmable product comprising a non-transitory computer readable medium having stored thereon computer executable instructions, which when executed by one or more processors, cause the one or more processors to carry out operations comprising:
receive sensor data associated with an accumulation of a plurality of particles on a photovoltaic (PV) panel, wherein the sensor data is received for each time interval of a plurality of predefined time intervals, and wherein the sensor data comprises particle data associated with the plurality of particles, tilt angle data and orientation data;
determine deposition rate data associated with the accumulation of the plurality of particles on the PV panel based on the sensor data, wherein the deposition rate data indicates a particle deposition rate for each tilt angle of one or more predefined tilt angles of the PV panel at each time interval of the plurality of predefined time intervals;
determine soiling loss data associated with the PV panel based on the deposition rate data, wherein the soiling loss data indicates a soiling loss for each tilt angle of the one or more predefined tilt angles of the PV panel at each time interval of the plurality of predefined time intervals;
determine correlation coefficient data for the PV panel based on the deposition rate data and the soiling loss data, wherein the correlation coefficient data indicates one or more correlation coefficients between the corresponding soiling loss and observational data, and wherein the observational data is based on the deposition rate data and the sensor data at corresponding time interval of the plurality of predefined time intervals;
generate one or more soiling maps associated with the PV panel based on the correlation coefficient data; and
output the one or more soiling maps for the PV panel.
